(19) United States
(12) Patent Application Publication
(10) Pub. No.: US 2026/0087350 A1
(43) Pub. Date: Mar. 26, 2026

(54) Method, system and software for resolving conflicts in a set of information

(71) Applicant: LIVEARENA TECHNOLOGIES INC., Bellevue, WA (US)

(72) Inventors: Strider AGOSTINELLI, Everett, WA (US); Anders NILSSON, Falköping (SE)

(21) Appl. No.: 18/892,679

(22) Filed: Sep. 23, 2024

(51) Int. Cl. G06N 3/0895

(52) U.S. Cl. CPC G06N 3/0895

(57) ABSTRACT

Method for resolving a conflict in a set of information (200), comprising the steps identifying and storing existing information sources (210) with existing source confidence metrics (232); existing topics (220); and existing pieces of content (240) with topic confidence metrics (251);
receiving a first piece of content (241) having a first information source (211); prompting large language model, LLM (150) to provide identified topics (222) addressed in the first piece of content (241); and
for each of the one or several identified topics (222) performing the following steps: identify an existing pieces of content (240) that is related to the identified topic (222); prompt a second LLM (160) to provide information regarding if the first piece of content (241) supports a particular existing piece of content (242); and
determine the first topic confidence metric (252) based on a source confidence metric (253) between the first information source (211) and the identified topic (222) as well as an existing topic confidence metric (254) for the identified topic (222) and the particular piece of content (242).

### BACKGROUND

The present invention relates to methods, systems and computer software for resolving conflicts in a set of information.

Systems for automatic information processing often need to process unstructured sets of information that are subject to dynamic change by amendment, addition and/or removal of individual pieces of the information set. Examples include customer support systems, decision support systems and data analysis systems.

Many times, information provided to such systems is fuzzy or even contradictory. Therefore, there is a need for a reliable solution to provide conflict resolution in such systems that yield predictable and repeatable results automatically, without human intervention.

One problem is that analysis and processing of unstructured information can quickly become very demanding in terms of compute, memory and so forth. Therefore, conflict resolution approaches are prone to becoming overly burdensome on the computer hardware on which they run.

Large language models (LLMs) have been known to be able to process unstructured data. However, LLMs have also been known to provide unreliable results.

Large language models are well-known per se, and will not be described in detail herein. However, what is meant herein by a “large language model” generally is or comprises a neural network-based model that has been trained on large volumes of text information for next-token-prediction, and that is arranged to receive a prompt and to respond by a textual response. Such LLM can be based on the per se well-known transformers architecture, possibly including mechanisms for multi-head self-attention and/or positional encoding, which is well-known as such. Well-known examples of such LLMs include GPT (Generative Pre-trained Transformer) models. Such LLMs can generally be configured to accept, as input, information of various modalities, such as text, images and sound data. Non-text input can, for instance, be provided by a textual prompt containing a link or reference to the non-text information.

### SUMMARY

Various embodiments of the present invention solve the above-described problems by utilizing LLM technology as a part of a methodology to provide reliable and efficient conflict resolution.

In some embodiments of the invention, a method for resolving a conflict in a set of information, comprises the steps
identifying and storing in one or several databases, in referenced and/or actual format,
a set of existing information sources;
a set of existing topics;
a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics;
receiving a first piece of content, the first piece of content being associated with a first information source, the first information source being an originator or provider of the first piece of content.

In some embodiments, the method further comprises
providing a first prompt to a first large language model, LLM, the first prompt being configured to request the first LLM to provide a set of identified topics addressed in the first piece of content; and
receiving, in a response from the first LLM, a first piece of response information comprising the set of identified topics.

In some embodiments, the method further comprises storing, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic.

In some embodiments, the method further comprises, for each of the one or several identified topics of the set of identified topics, the identified topic forming part of the set of existing topics, performing the following steps:
identify a first subset of the existing pieces of content that are related to the identified topic;
provide a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receive, in a response from the second LLM, a second piece of response information indicating that the first piece of content contradicts a particular existing piece of content of the first subset of existing pieces of content; and
determine the first topic confidence metric based on a source confidence metric between the first information source and the identified topic, the first topic confidence metric further being determined based on an existing topic confidence metric for the identified topic and the particular piece of content.

In some embodiments, one or several, such as each, of the existing topics in the set of existing topics is stored as vectorized information.

In some embodiments, one or several, such as each, of the existing topics in the set of existing topics is stored as plaintext information.

In some embodiments, one or several, such as each, of the existing pieces of content in the set of existing pieces of content is stored as vectorized information.

In some embodiments, one or several, such as each, of the existing pieces of content in the set of existing pieces of content is stored as plaintext information.

In some embodiments, the first piece of content is plaintext information.

In some embodiments, the method further comprises identifying a set of potential topics comprised in the first piece of content.

In some embodiments, the method further comprises providing the set of potential topics in the first prompt, the first prompt being configured to request the first LLM to provide the set of identified topics so that the identified topics are one or several of the potential topics that are actually addressed in the first piece of content.

In some embodiments, the identifying of the set of potential topics comprised in the first piece of content is performed based on the set of existing topics, such as identifying the set of potential topics as a second subset of the set of existing topics.

In some embodiments, the set of potential topics is identified using a distance measure between a vectorized form of the first piece of content and respective vectorized forms of the set of existing topics.

In some embodiments, the set of potential topics is identified using a text search between a plaintext form of the first piece of content and respective plaintext forms of the set of existing topics.

In some embodiments, the first subset of the existing pieces of content that are related to the identified topic is identified using a similarity search between a vectorized form of the identified topic and respective vectorized forms of the set of existing pieces of content.

In some embodiments, the first subset of the existing pieces of content that are related to the identified topic is identified using a text search between a plaintext form of the identified topic and respective plaintext forms of the set of existing pieces of content.

In some embodiments, each of the existing source confidence metric comprises information reflecting whether an individual information source associated with the existing source confidence metric is a primary, secondary and/or tertiary information source for the individual existing topic.

In some embodiments, the method further comprises identifying an additional information source occurring in the first piece of content and identifying that the first piece of content refers to information regarding an additional topic the source of which is the additional information source; and determining that the first information source is a secondary information source for the additional topic.

In some embodiments, the method further comprises providing a third prompt to a third LLM, the third LLM being the same as or different from the first and/or second LLM, the third prompt being configured to request the third LLM to provide information regarding any additional sources of information referred to in the first piece of content and topics referred to by such additional sources of information; and receiving, in response from the third LLM, a third piece of response information regarding the additional information source and the additional topic.

In some embodiments, the method further comprises the steps:
determining that a particular topic of the first piece of content does not exist in the set of existing topics; and
as a result thereof, storing in the one or several databases:
to the set of existing topics, the particular topic; and
to the set of existing associations between pairs of individual ones of the existing information sources and individual ones of the existing topics, an association between the first information source and the particular topic with a default source confidence metric.

In some embodiments, each of the existing topics in the set of existing topics is additionally associated with zero or more related topics.

In some embodiments, the storing of the first piece of content comprises storing, with the first piece of content, metadata regarding the first piece of content.

In some embodiments, the method further comprises splitting the first piece of content into two or more separate pieces of content; and using each of the two or more separate pieces of content as the first piece of content.

In some embodiments, the splitting of the first piece of content into two or more separate pieces of content is configured to result in a partial overlap between the two or more separate pieces of content.

In some embodiments, the method further comprises continuously reading an available alphanumeric stream of information; parsing or splitting the alphanumeric stream of information into a sequence of separate pieces of content; and using the sequence of separate pieces of content as the first piece of content.

In some embodiments, the available alphanumeric stream of information is a chat or other text-based communication involving at least two participants, or a transcript of a non-text communication involving the at least two participants.

In some embodiments, each participant is noted as an information source for each communication message produced by that participant.

In some embodiments, at least one of the at least two participants is an automated communication bot.

In some embodiments, the determining of the first topic confidence metric for the combination of the first piece of content and the identified topic is performed at a later point in time, after a second piece of content has been received and processed as the first piece of content.

In some embodiments, the method further comprises determining that the existing topic confidence metric indicates a higher confidence than the source confidence metric; and as a result, determining the first topic confidence metric to indicate a lesser confidence than the existing topic confidence metric.

In some embodiments, the determining of the first topic confidence metric is performed using one or several of:
adjusting the first topic confidence metric by multiplying the first topic confidence metric with a function of a negated value of the existing topic confidence metric;
forming a weighted average or geometric mean of the first topic confidence metric and the existing topic confidence metric, and using the weighted average or geometric to determine the first topic confidence metric;
calculating the first topic confidence metric using a Bayesian statistic model; and
calculating the first topic confidence metric using a maximum likelihood model; and
a neural network trained on historic information regarding adjustments of source confidence 232 and/or topic confidence metrics.

In some embodiments, the method further comprises the steps:
receiving an information request, the information request being in the form of a query or question;
identifying a topic present in, or related to, the information request;
identifying a set of related pieces of content, each related piece of content in the set of related pieces of content forming part of the set of existing pieces of content and being associated with the identified topic or a topic being related to the identified topic based on a predetermined metric;
determining a third subset of the set of related pieces of content having highest respective topic confidence metric for the identified or related topic; and
providing a response to the information request based on the third subset of the set of related pieces of content.

In some embodiments, the identifying of the topic present in, or related to, the information request is performed using a similarity search using the set of existing topics being stored in a vectorized form.

In some embodiments, the set of existing information sources, the set of existing topics, the set of existing associations between pairs of individual ones of the existing information sources and individual ones of the existing topics and the set of existing pieces of content are stored on a blockchain.

In some embodiments, the blockchain is caused to comprise a smart contract configured to automatically update a topic confidence metric as a result of the introduction of the first piece of content into the blockchain.

In some embodiments, the introduction of the first piece of content into the blockchain is performed using a consensus algorithm.

Furthermore, some embodiments of the invention relate to a system for resolving a conflict in a set of unstructured information, the system comprising a central server arranged to Identify and store, in one or several databases, in referenced and/or actual format,
a set of existing information sources;

a set of existing topics;

a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics.

In some embodiments, the central server is further arranged to receive a first piece of content, the first piece of content being associated with a first information source, the first information source being an originator or provider of the first piece of content; the central server further being arranged to provide a first prompt to a first large language model, LLM, the first prompt being configured to request the first LLM to provide a set of identified topics addressed in the first piece of content;
the central server further being arranged to receive, in a response from the first LLM, a first piece of response information comprising the set of identified topics; and
to store, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic.

In some embodiments, the central server is further arranged to, for each of the one or several identified topics of the set of identified topics, the identified topic forming part of the set of existing topics, perform the following steps:
identify a first subset of the existing pieces of content that are related to the identified topic; provide a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receive, in a response from the second LLM, a second piece of response information indicating that the first piece of content contradicts a particular existing piece of content of the first subset of existing pieces of content; and determine the first topic confidence metric based on a source confidence metric between the first information source and the identified topic, the first topic confidence metric further being determined based on an existing topic confidence metric for the identified topic and the particular piece of content.

Moreover, some embodiments of the invention relate to a computer program product for resolving a conflict in a set of unstructured information, the computer program product being arranged to, when executing on one or several processors, identifying and store in one or several databases, in referenced and/or actual format, a set of existing information sources;
a set of existing topics;
a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics.

In some embodiments, the computer program product is further arranged to, when executing on the one or several processors,
receive a first piece of content, the first piece of content being associated with a first information source, the first information source being an originator or provider of the first piece of content;
provide a first prompt to a first large language model, LLM, the first prompt being configured to request the first LLM to provide a set of identified topics addressed in the first piece of content;
receive, in a response from the first LLM, a first piece of response information comprising the set of identified topics; and
store, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic.

In some embodiments, the computer program product is further arranged to, when executing on the one or several processors, for each of the one or several identified topics of the set of identified topics, the identified topic forming part of the set of existing topics, perform the following steps:
identify a first subset of the existing pieces of content that are related to the identified topic;
provide a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receive, in a response from the second LLM, a second piece of response information indicating that the first piece of content contradicts a particular existing piece of content of the first subset of existing pieces of content; and
determine the first topic confidence metric based on a source confidence metric between the first information source and the identified topic, the first topic confidence metric further being determined based on an existing topic confidence metric for the identified topic and the particular piece of content.

The computer program product may be implemented by a non-transitory computer-readable medium encoding instructions that cause one or more hardware processors located in the system to perform the above-described method steps.

### BRIEF DESCRIPTION OF THE DRAWINGS

In the following, the invention will be described in detail, with reference to exemplifying embodiments of the invention and to the enclosed drawings, wherein:

FIG. 1 illustrates a system along with various other entities, in accordance with some embodiments;

FIG. 2 illustrates a central server, in accordance with some embodiments;

FIG. 3 is a flowchart illustrating a first method, in accordance with some embodiments;

FIG. 4a illustrates a first flow of information, in accordance with some embodiments;

FIG. 4b illustrates a second flow of information, in accordance with some embodiments; and

FIG. 5 is a flowchart illustrating a second method, in accordance with some embodiments.

### DETAILED DESCRIPTION

Embodiments of the present invention achieve dynamic conflict resolution in sets of information that are subject to change dynamically, the conflict resolution potentially being applied in real-time. Furthermore, embodiments of the present invention provides automatic conflict resolution for unstructured information sets.

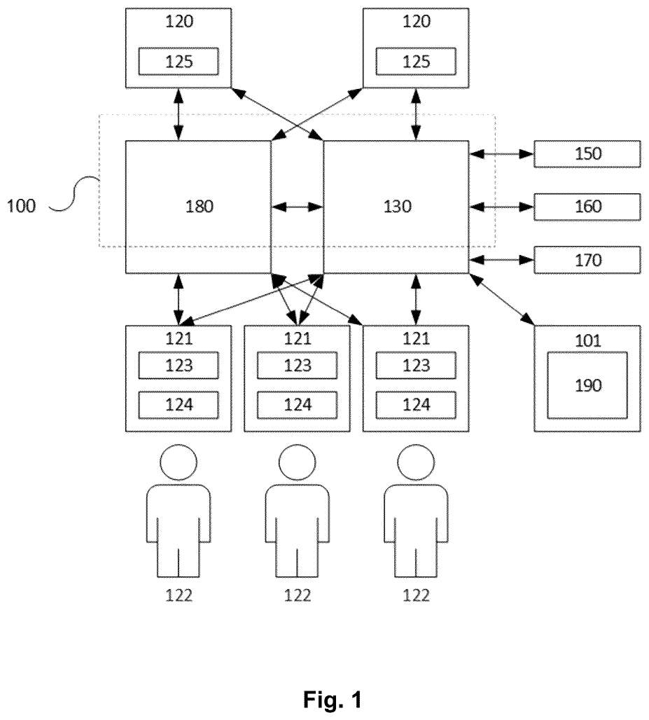

FIG. 1 illustrates a system 100, configured to perform a method of the type described herein, for resolving a conflict in a set of information 200. The information 200 can be structured in the sense that it is stored in a predetermined, structured data format. The information 200 can also be unstructured in the sense that individual parts of the information 200 is unstructured information, such as pieces of text in a free-form format not according to any predetermined complex data structure, text schema, text formatting or similar.

The set of information 200 can be or comprise textual information, in other words any type of information being electronically and digitally stored in a text format. This is true individually regarding both an existing set of information and an incoming additional piece of information resulting in a potential conflict to the combination of the existing set of information and the incoming additional piece of information. Such a text format can be plaintext, but it can also be compressed, encrypted, encoded and so forth, as long as the system 100 is configured to transform the stored textual information into corresponding alphanumeric characters. Any part of the set of information 200 can contain one or several sub-pieces, such as individual pieces of information that each can be a statement, a sentence, a piece of text, and so forth. A respective textual information of each such sub-piece can individually be sequential, in other words it can have a well-defined order sequence, for instance in the form of a series of words forming a sentence or a multi-sentence text. Normally, the systems and methods described herein are arranged to process textual information according to such defined sequence order.

The system 100 may be or comprise a central server 130.

As used herein, the term “central server” is a computer-implemented functionality that is configured to be accessed in a logically centralized manner, such as via a well-defined API (Application Programming Interface). The functionality of such a central server may be implemented purely in computer software, or in a combination of software with virtual and/or physical hardware. It may be implemented on a standalone physical or virtual server computer or be distributed across several interconnected physical and/or virtual server computers.

The physical or virtual hardware that the central server 130 runs on, in other words the physical or virtual hardware that computer software defining the functionality of the central server 130 executes on, may comprise a per se conventional CPU, possibly a per se conventional GPU or NPU, a per se conventional RAM/ROM memory, a per se conventional computer bus, and a per se conventional external communication functionality such as an internet connection.

FIG. 1 also shows a querying device 120, such as a client. The querying device 120 can also be a central server in the above sense with the corresponding interpretation, and physical or virtual hardware that the querying device 120 runs on, in other words that computer software defining the functionality of the querying device 120 executes on, may also comprise a per se conventional CPU/GPU/NPU/xPU, a per se conventional RAM/ROM memory, a per se conventional computer bus, and a per se conventional external communication functionality such as an internet connection.

The system 100 can comprise the querying device 120, or even several such querying devices 120, and/or one or several querying devices 120 can be external to the system 100. Alternatively, the querying device 120 is external to the system 100.

The system 100, such as the central server 130 or a different central server 180 of the system 100, can be configured to provide a video communication service involving two or more participating clients 121 that in turn also can be central servers in the above sense and with the corresponding interpretation. Such video communication service can be configured to allow human users 122 of the participating clients 121 to communicate with each other, digitally and automatically, using video and/or audio, via their respective participating clients 121.

However, the system 100 can also or alternatively be arranged to provide non-video communication services to human users 122 and/or to machine users via clients 121. For instance, the system 100 can be arranged to keep track of the set of information 200, for instance in a logically centralized manner, for the benefit of various human or machine users 122 of the system 100. In such embodiments, various such human and/or machine users 122 can contribute or add various pieces of information to the central server 130, in turn being tasked to continuously or intermittently resolve conflicts that arise in the set of information 200 as a result of such contributions or additions. This resolution, that takes place in the various ways as described herein, provides a continuously updated and conflict-resolved set of information 200. The central server 130 can then provide the possibility for querying device(s) 120 to query the resolved information for various follow-up information, answers to specific questions, and so forth, based on the set of information 200.

In a concrete example, the system 100 is used to keep track of unstructured information 200 regarding a certain person or actor or avatar, for instance opinions or facts attributed to the person, actor or avatar. Then, the conflict-resolved information 200 kept and maintained by the central server 130 can be used by an LLM-based chatbot or similar enacting the person, actor or avatar. The LLM-based chatbot can be or use a querying device 120 to this end.

In another example, the system 100 is used to keep track of unstructured information 200 regarding a certain project, entity or subject, such as a news event or a technical development project. Then, various interested parties, such as being or using a querying device 120, can both provide updated information regarding the project, entity or subject, and also query information, such as the latest status or regarding historic status, of the project, entity or subject.

In the case of a video communication service, the central server 130 can be tasked to keep a conflict-resolved set of information 200 pertaining to an ongoing meeting being provided to the participants 122 via the video communication service and/or regarding a particular subject being discussed in such meeting.

Each of the one or more querying devices 120 and each of the one or more participant clients 121 can individually comprise or be in communication with a respective computer screen, configured to display video content, for instance as a part of an ongoing video communication of said type; one or several respective loudspeakers, such as configured to emit sound content provided as a part of said video communication; one or several respective video cameras; and one or several respective microphones, for instance configured to record sound locally to a user 122 to said video communication, the user 122 using the participant client 121 in question to participate in said video communication.

In other words, a respective human-machine interface of each participant client 121 can be configured to allow a respective user 122 to interact with the participant client 121 in question, in a video communication, with other users and/or audio/video streams provided by various sources.

In general, each of the querying devices 120 and each of the participating clients 121 can individually comprise a respective input means 123, that may comprise said video camera(s); said microphone(s); a keyboard; a computer mouse or trackpad; and/or an API to receive a digital video stream, a digital audio stream and/or other digital data. The input means 123 can be specifically configured to receive a video stream and/or an audio stream from a central server, such as from the central server 180, such a video stream and/or audio stream being provided as a part of a video communication and possibly being produced based on corresponding digital data input streams provided to the central server 180 from at least two sources of such digital data input streams, for instance one or several of the participant clients 121 and/or from one or several external information sources.

Further generally, each of the querying devices 120 and each of the participating clients 121 can individually comprise a respective output means 124, that may comprise said computer screen; said loudspeaker(s); and an API to emit a digital video and/or audio stream, such audio stream being representative of a captured video and/or audio locally to the participant 122 using the participant client 121 in question.

In practice, each querying device 120 and each participant client 121 can individually be a mobile device, such as a mobile phone, arranged with a screen, a loudspeaker, a microphone and an internet connection, the mobile device executing computer software locally or accessing remotely executed computer software to perform the functionality of the querying device 120 or the participant client 121 in question. Correspondingly, the querying device 120 and the participant client 121 may alternatively individually be a thick or thin laptop or stationary computer, executing a locally installed application, using a remotely accessed functionality via a web browser, and so forth, as the case may be. Each querying device 120 and each participant client 121 can also individually comprise or be connected to any peripherally connected equipment, such as any external cameras, microphones and/or loudspeakers.

There may be more than one, such as at least two, at least three or even at least four, participant clients 121 used in one and the same video communication.

Each querying device 120 can individually be one and the same logical or physical unit as one of the participant clients 121. Then, a result of processing of the set of information 200 described herein, such as a query posed by the client 121 to the central server 130 or provided by the central server 130 to the client 121 based on a different trigger than a specific query, can be used by the participant client 121 when providing the video conference experience to the corresponding user 122 or when determining information to be sent to the central server 180 providing the video conference experience. In other embodiments, the central server 130 can provide results of processing of the set of unstructured information to a querying device 120 that is external to the system 100 and not directly involved in the video communication service.

In some cases, the querying device 120 can be an internal part of the system 100, acting autonomously as a part of a larger information processing activity. For instance, an autonomous entity 125 in the form of an automatic “bot” type functionality can be configured to continuously, intermittently or discretely analyze a course of events within the video communication service. As a part of such analysis, the entity 125 can process textual information, for instance to take decisions regarding what information to provide to a requesting entity; making automatic video production decisions in the form of text-format production commands for automatic execution by the server 180 and/or based on text-format descriptions of events and/or states in and/or of the video communication service; providing a summary of the course of events; and so forth. The textual information can be automatically extracted from the video communication service, e.g. from the server 180, such as in the form of an automatically provided transcript of speech detected in the context of the video communication service; or in the form of an automatically produced textual description of a certain course of events in the context of the video communication service. The latter can, for instance, be produced based on automatic image analysis, such as using a trained neural network, of one or more video streams occurring within the video communication service, in combination with a textual processing, such as using an LLM, of metadata describing the video stream and deducted using the automatic image analysis.

An autonomous entity 125 in the form of such an automatic “bot” functionality can further be configured to provide meeting summaries for participants after a video communication service has ended. As a part of this task, the entity 125 can process textual information such as transcripts and generate a (possibly concise) summary of a discussion held between the participants during the video communication service meeting, such as by identifying and mentioning/describing key topics and action items. It can also use metadata from video streams occurring in or in connection to the video communication service to track speaker participation and to provide insights on who contributed to different discussion points. The textual information can be extracted from both speech-to-text outputs and metadata associated with the interaction dynamics, allowing for detailed post-meeting reports.

An autonomous entity 125 in the form of such an automatic “bot” functionality can further be configured to monitor the video communication service for compliance with pre-defined content standards. As a part of this task, the autonomous entity 125 can analyze textual information from speech-to-text transcripts, identifying and flagging inappropriate language or content. In addition, it can generate real-time alerts to moderators or apply automatic filters to remove or mute certain parts of the video communication service. The textual information used by the autonomous entity 125 could include speech-to-text data, contextual metadata, or keyword triggers provided by the central server 180.

Moreover, an autonomous entity 125 in the form of such an automatic “bot” functionality can be configured to monitor ongoing video communications in real-time and send notifications based on certain trigger events. As a part of such monitoring, the autonomous entity 125 can analyze available or deduced textual information to detect and notify users of key moments, such as speaker changes or specific keywords being mentioned. The bot could also provide real-time video control recommendations, such as switching camera feeds based on who is speaking or generate a real-time summary of discussion points during the process of the video communication service. Textual information for these tasks can be derived from live transcripts and/or metadata related to the participants' interactions, extracted automatically from the video communication service by the central server 180.

It is realized that these various examples regarding the possible capabilities and tasks of the autonomous entity 125 are not meant to be exhaustive, and that the examples can be combined in any manner.

At any rate, the autonomous entity 125 can be configured to provide information, such as continuously updated information gathered in any of the ways discussed above, to the central server 130 keeping the conflict-resolved and updated set of information 200. The central server 130 can use this added information to enrich the set of information 200, including any additional conflict resolving as required. Then, the autonomous entity 125, or any other corresponding autonomous entity 125, can use the updated set of information 200 as a resource, for instance by querying the central server 130, for deciding what to do next in terms of automatic video production decisions, resource allocation or task planning.

For instance, the set of conflict-resolved information 200 can be or comprise a description of the course of events that have taken place during the course of activities within a video communication service, such as in a video communication meeting, possibly including a set of subjective assessments or interpretations made by one or several participants 122 regarding one or several subjects, for instance regarding the course of events itself. The autonomous entity 125 can then query the central server 130 for information regarding the course of events for use by the autonomous entity 125 to produce an automatic summary of the course of events for a newly entering participant 122.

In a different example, the set of conflict-resolved information 200 can be, or be comprised in, a defining set of information based on which an avatar is defined in terms of background knowledge, behavior, etc., of the avatar. Additional information regarding the avatar can be fed or otherwise provided from various sources, and an autonomous entity 125 can use the conflict-resolved information 200 when calculating possible responses to queries the avatar may be posed. For instance, parts of the set of conflict-resolved information 200 can form part of, or be used when determining, a textual prompt to an LLM impersonating a person in the form of the avatar or otherwise providing functionality representing the avatar based on responses to such textual prompts.

As discussed, the central server 130 and/or the entity 125 can automatically produce a video stream within the context of the video communication service. Such automatic production of the video stream is performed by taking automatic production decisions. As the term is used herein, “automatic production” of a video stream generally denotes the automatic application, by a suitably configured piece of computer software program executing on a central server of the above-described type, of a series of production decisions involving one or several input streams, such as input moving images, and resulting in one or several output streams. Such automatic production can be controlled on the basis of parameters and/or one or several trained neural networks.

In general, the examples provided above regarding possible functionalities of, and uses for, the devices 120, 121 is not exhaustive, and may be combined in any way suitable.

FIG. 1 also shows a first neural network or LLM 150, a second neural network or LLM 160 and a third neural network or LLM 170. It is understood that an LLM comprises one or several neural networks, such as several layers and/or parallel neural network “heads”. In the following, 150, 160 and 170 will be referred to as “LLM: s” for brevity, knowing that each of 150, 160 and 170 can each refer to a complete LLM or merely one or several trained neural networks that in turn can form part of an LLM or of some other neural network-based functionality for processing language using such one or several trained neural networks.

The first, second and third LLM: s 150, 160, 170 can each be configured to communicate with the central server 130 by the central server 130 posing queries or requests, in the form of prompts, to any of the LLM: s 150, 160, 170, and the LLM 150, 160, 170 then being configured to automatically respond to such prompts to the central server 130. It is realized that the LLM: s are shown in FIG. 1 to be external to the system 100, but that they individually can alternatively be internal to the system 100. In some embodiments, the central server 130 comprises one or several such LLM: s 150, 160, 170.

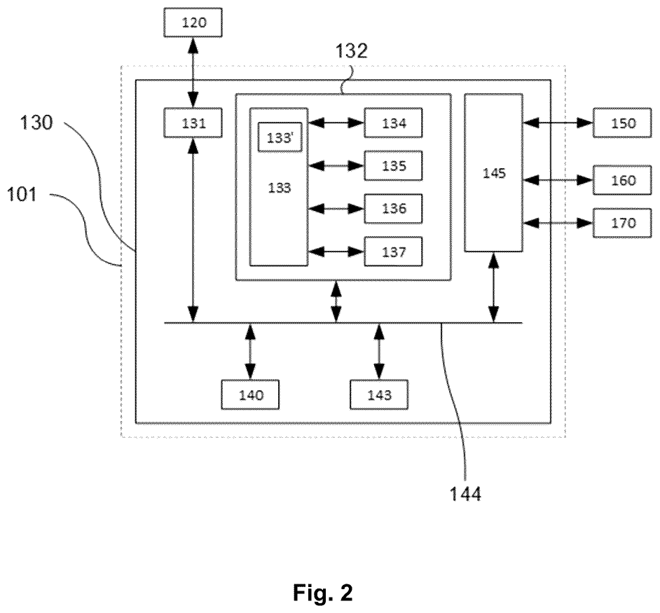

FIG. 2 illustrates in closer detail a possible embodiment of the central server 130.

The central server 130 comprises an external digital communication interface 131, such as an internet interface. The interface 131 can be a HTTP interface, that can be configured to allow communication between the central server 130 and an external entity, such as the querying device 120 or 121.

The central server 130 further comprises a digital memory 140, such as a RAM memory. The memory 140 can be arranged to store both the set of information 200 and a computer software program being configured to perform a method, in whole or part, of the type described herein when executed on a computing unit 143 of the central server 130.

Namely, the central server 130 can further comprise the computing unit 143 in question, such as in the form of a per se conventional CPU and/or GPU.

The central server 130 further comprises a piece of logic 132, being implemented in software and/or hardware as is per se conventional. The logic 132 can comprise a main algorithm or logic 133 implementing at least part of each of the methods described herein. The algorithm will normally be embodied as software, but can instead or additionally comprise hardware-implemented logic. The main algorithm 133 comprises or is configured to utilize various sub logics of corresponding type, such as a first binary data transformation 134 and/or an embedding data transformation 135, a reverse embedding data transformation 136 and/or a second binary data transformation 137. These sub logics will be described below.

The logic 132 also comprises a parser 133′, which is indicated as part of the main algorithm or logic 133 but alternatively can be a standalone module of the logic 132. The parser 133′ is configured to, when executing, parse an incoming query, request or piece of information. The parsing can, for instance, be according to a predetermined data syntax or a parsing of a free-text piece of information into corresponding plaintext tokens, words and/or text parts.

The central server 130 further comprises an LLM interface 145, configured to allow the central server 130 to communicate with the LLM: s 150, 160, 170. As discussed above, the LLM: s 150, 160, 170 can also be comprised as respective parts of the central server 130. The interface 145 can utilize any suitable digital communication protocol, in particular as described above in relation to interface 131. In some embodiments, the interfaces 131, 145 are one and the same hardware and/or software interface.

The central server 130 also comprises a communication bus 144, allowing the various parts 131, 132, 140, 143, 145 to communicate one with the other.

In some embodiments, the central server 130 is a discrete physical hardware component, whereby one or several of the parts 131, 132, 140, 143, 145 (any combination of one or more of these parts) are enclosed within one and the same physical enclosure.

As used herein, a “topic” is an entity or subject within a dataset of existing information. Examples of topics include “John” and “pizza”. A “piece of content” is some information relating to at least one topic, such as a statement about one or several topics. An example is “John likes pizza”. A “confidence metric” is a metric representing a trustworthiness or likely truth of a subject. The trustworthiness can be a priori decided, inferred, calculated, updated and so forth. An example is “90% confident” or, correspondingly, the value 0.9. A “primary information source” is a highly trusted, such as a most highly trusted, source of information. In examples, each primary information source is assigned a confidence rating of 100%, or corresponding value, with respect to any topic for which it is a primary information source. A “provisional topic” is a topic that lacks any well-defined associated sources of information, or that lacks any primary information sources. A “secondary information source”, “tertiary information source”, and so forth, in relation to a particular topic, is a source of information for the particular topic that is not the or a primary (or secondary, etc.) information source for a particular topic.

Primary/secondary/tertiary/etc. information source status of a particular information source with respect to a particular topic can be set manually, for instance by an operator of the system 100, and/or be determined automatically as will be exemplified below.

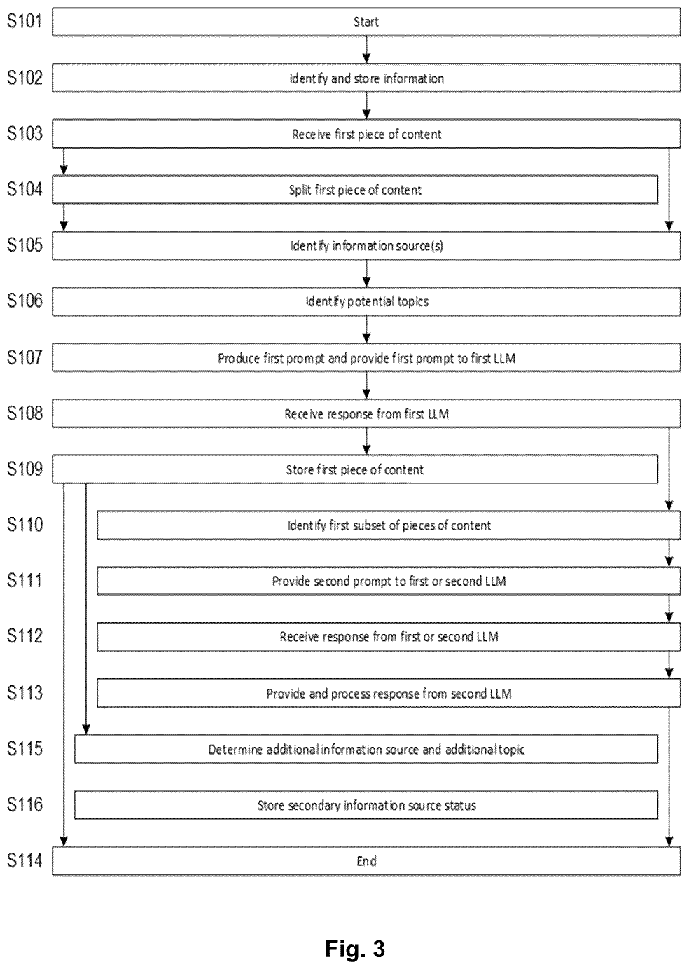

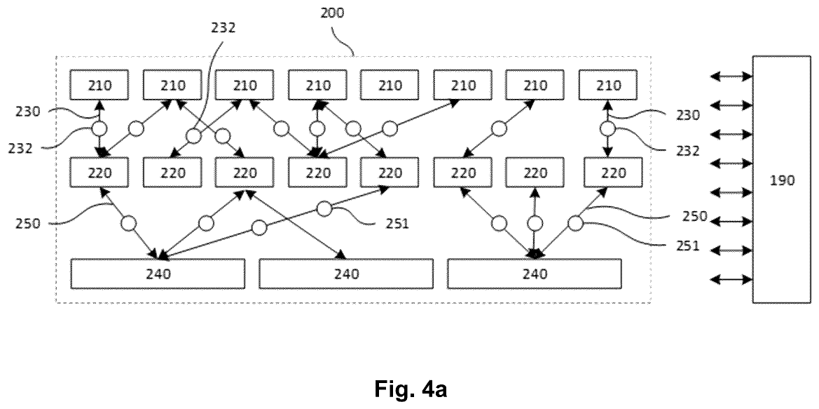

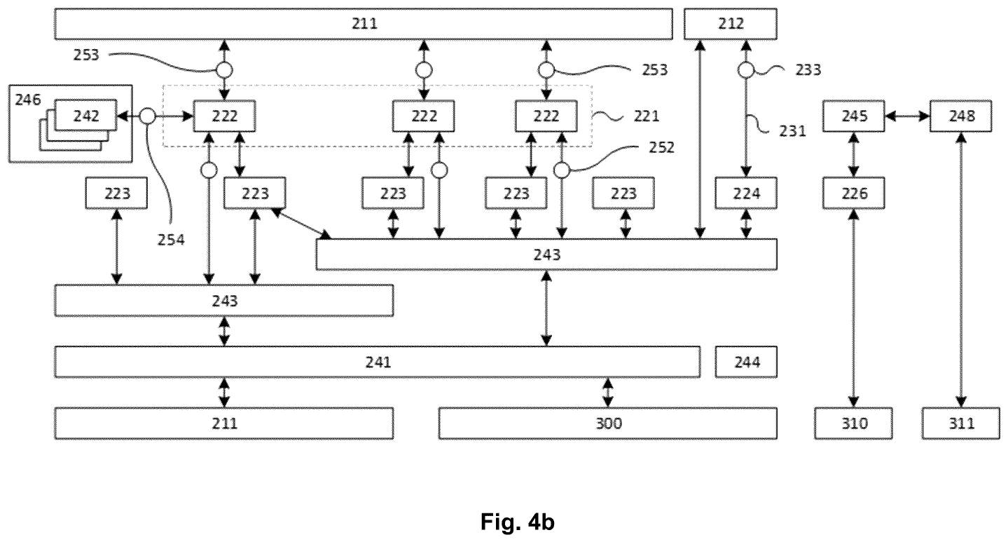

FIG. 3 is a flowchart illustrating a method for resolving a conflict in a set of unstructured information. Such a method, as well as the various informational component parts involved in the method, is also generally illustrated, by way of example, in FIGS. 4a and 4b. If not stated otherwise, the central server 130 can be the entity performing the steps of the method, for instance upon request or information provision from any device 120 or 121.

Each method step can also be individually performed by an entity not being the central server 130, such as via delegation from the central server 130 or under supervision by the central server 130. Unless stated otherwise, each part of the various methods described herein is performed automatically, digitally and electronically.

In a first step S101, the method starts.

In a subsequent step S102, the central server 130 identifies and stores information about at least the following: A set of existing information sources 210; a set of existing topics 220; a set of existing associations 230 between pairs of individual ones (or several) of the existing information sources 210 and individual ones (or several) of the existing topics 220; and a set of existing pieces of content 240.

This identified and stored information can be identified, such as received, deduced and/or constructed, by the central server 130 in one go, over a certain time, and so forth. In particular, the information can be built up over time as the presently described method is performed iteratively, effectively building and ameliorating the information across several such iterations. Hence, step S102 can be performed ahead of time and/or iteratively and incrementally.

Moreover, the information can be stored in a suitable memory or database, such as in memory 140 and/or in any other system-internal or system-external memory or database, in a centralized or distributed manner. What is important is that the central server 130 has access to reading and writing the information.

Each information source 210 can be a reference to a particular human or group of humans and/or machines; a logical entity such as a newspaper, an article, a piece of law, an opinion, and similar; and so forth. The central server 130 stores at least sufficient information so as to be able to unambiguously identify and keep track of the information source 210.

Each existing topic 220 can be a physical or logical entity, such as a human being or a thing; an activity; an opinion; a decision; and so forth. The central server 130 stores at least sufficient information to be able to unambiguously identify and keep track of the existing topic 220.

Each association 230 is a reference or connection between an individual (or several) existing information source(s) 210 and an individual (or several) existing topic(s) 220. That an existing topic 220 is associated with a particular existing information source 210 signifies that the individual existing information source 210 is a source of information in relation to the individual existing topic 220. The central server 130 stores at least sufficient information to be able to unambiguously identify and keep track of the associations 230.

Each piece of content 240 is a well-defined piece of information having a cognitive content that is expressed in a suitable manner. In various embodiments, the piece of content 240 is or comprises text. The central server 130 stores, for each one of the pieces of content 240, the piece of content 240 itself or a reference to the piece of content 240.

As illustrated in FIG. 4a, at least one, several or each existing association of the set of associations 230 comprises or is associated with an associated existing source confidence metric 232.

As similarly illustrated in FIG. 4a, at least one, several or each existing piece of content of the set of existing pieces of content 240 is associated with one or several associated ones of the existing topics 220. The central server 130 can store at least sufficient information to be able to unambiguously identify and keep track of the associations 250.

Moreover, at least one, several or each existing piece of content of the set of existing pieces of content 240 is also associated with a respective existing topic confidence metric 251 for each of the one or several ones of the existing topics 220 that is associated with the existing piece of content in question. The topic confidence metric 251 for a particular piece of content with respect to a particular topic can be thought about as a metric regarding the probable veracity of the piece of content with respect to the topic in question. The topic confidence metric 251 can be formulated as a probability for the piece of content (or the statement forming part of or being the piece of content) to be true. Each topic confidence metric 251 can be revised as new information is added to the set of information 200, and in particular by additional pieces of information being added, from one or several information sources having respective source confidence metrics, that support or conflicts with the original piece of content.

Each, or at least several, or at least one, of the existing source confidence metrics 232 and/or each of the existing topic confidence metrics 251 can individually be expressed or interpretable as a number, such as a percentage, between a lowest possible confidence and a highest possible confidence. In examples, each of the existing source confidence metrics 232 and/or each of the existing topic confidence metrics 251 is a number between 0 and 1, where 0 means no or very low confidence and 1 means full or very high confidence.

The central server 130 can be configured to store information regarding each of the existing topics 220 in a vector store, in vectorized format. As used herein, the term “vector store”, “vectorized format”, “vector”, etc. refers to information that has been transformed into one or several vectorized tokens. Such vectorization is also known as “embedding” meaning that such information is mapped onto a unique multidimensional vector value in a multidimensional vector space. The “transformation” here can be the embedding data transformation 135 mentioned above. The data being transformed into the vector space can first be transformed into a suitable binary format, such as using the first binary data transformation 134. To translate an available vectorized piece of data back into a non-vectorized format, the reverse embedding data transformation 136 can be used, and to transform such a non-vectorized but binary format into a textual format, the second binary data transformation 137 can be used.

The dimensionality of said vector space can vary, but is normally at least 100, or at least 1000. The vectorization can use a predetermined or at least deterministic bijective (one-to-one) mapping of a piece of information, such as a textual piece of information, to a particular vector representation of the piece of information such that the piece of information and/or any subpart of the piece of information can be unambiguously mapped to and from exactly one vector representation. This mapping can be determined ahead of time in any suitable manner, such as using a trained neural network to define the mapping in a way so that the respective vector representations (embeddings) of different pieces of information relate geometrically to each other in ways reflecting various semantic connections and associations among the pieces of information in question. For instance, geometric closeness of two different vectors in the vector space can imply semantic correlation or dependence between the corresponding different pieces of information. Such embedding mappings and their determination are well-known as such, and will not be detailed herein. In general, however, one known way of mapping a piece of text onto a particular vector representation is to parse the piece of text into a set of tokens, where each token can represent an individual word or part of an individual word, and then to form the vector representation of the text by combining, such as using addition with or without weights, of the individual vector representations of each of the resulting tokens.

Any informational content stored and processed by the central server 130, in particular textual information, can be stored using such a vector representation. This allows the central server 130 to compare and relate the cognitive contents, interpretation and/or significance of such pieces of information to each other.

In examples, for each one of the existing topics 220, the information stored by the central server 130 can comprise one or several of the following fields:
Topic ID: A system-unique ID used for direct lookups and references to topics. In the case a topic is a participant 122, the topic ID can be an employee identification of similar.
Topic name: The name of the name (e.g., “John”).
Related topics: A list of references to any topics related to this one (e.g., [“Pizza”]).
Descriptions: Detailed description(s) of the topics (e.g., “User John”).

A concrete example of information stored in relation to a topic is the following, where it is understood that each of the textural contents can be stored in plaintext, encoded, compressed and/or vectorized format:

```
{
  “Topic ID”: “user_1234”,
  ″Topic name″: ″John Doe″,
  ″Related topics″: [″Personnel″, “Accounting”],
  ″Descriptions″: ″The User: John Doe″
}
```

The existing information sources 210 can be stored in a similar or corresponding manner. Concretely, all known information sources 210 can be listed together with, or referencing, corresponding existing associations 230 to existing topics 220. Each existing information source 210 can also reference or contain information regarding behavior of the existing information source with respect to its eventual capacity as primary, secondary, tertiary or similar source of information.

In examples, for each one of the existing information sources 210, the information stored by the central server 130 can comprise one or several of the following fields:
Source ID: Unique identifier for the existing information source. In the case of sources in the form of a participant 122, things like a corresponding employee identification can be used in this field.
Source name: The name of the information source (e.g., “John Doe”).
Source type: The type of the information source (e.g., “user”, “system”).
Default confidence override: If this is set, instead of the default confidence on provisional topics, this existing information source uses this value instead. (e.g., 0.9).
Can create provisional topics: If true, this information source is allowed to create new provisional topics.

A concrete example of information stored in relation to an information source is the following, where again any textual information can be stored in plaintext, encoded, compressed and/or vectorized format:

```
{
  ″Source ID″: “user_1234”,
  ″Source name″: “John Doe″,
  ″Source type″: ″user″,
  ″Default confidence override: null,
  ″Can create provisional subjects: True
}
```

The stored associations 230 between pairs of individual ones of the existing information sources 210 and individual ones of the existing topics 220 establish the relationships between information sources and topics. Together with the corresponding existing source confidence metrics 232, that can include information such as the level of truth or trustworthiness, and manually added confidence scores, this dataset makes it possible to determine trustworthiness and relevance of individual pieces of content provided by or from various existing information sources 210 in relation to different existing topic 220.

In examples, for each one of the associations 230, the information stored by the central server 130, can comprise one or several of the following fields:
Source ID: Unique identifier for the information source (e.g., “user_1234”).
Topic ID: Unique identifier for the topic (e.g., “topic_5678”).
Truth level: Indicates the reliability of the specific information source in relation to the specific topic (e.g., “primary”, “secondary”, “manual”, “none”).
Manual confidence: A float value between 0 and 1 indicating the manual confidence level of the information source for the topic (e.g., 0.75). Ignored if “Truth level” is not set to “manual”.
Process immediately: This value is used for data processing. If True, the central server 130 can be configured to process new content from this specific information source and related to this specific topic immediately in order to ensure that the stored data is as-up-to-date as possible.

A concrete example of information stored in relation to an existing association 230 is the following, where again any textual information can be stored in plaintext, encoded, compressed and/or vectorized format:

```
{
  ″Source ID″: ″user_1234″,
  ″Subject ID″: ″ user_1234″,
  ″Truth level″: ″primary″,
  ″Manual confidence″: 1,
  ″Process immediately”: False
}
```

Regarding the existing pieces of content 240, they can be stored by the central server 130 comprising one or several of the following fields, such as including processed content, including context, source, and/or the respective topic confidence metric associated with each topic:
Content ID: Unique identifier for the content.
Source ID: Identifier for the information source for the content.
Content: The actual content data (e.g., “John likes Pizza”).
Context: Additional context for the content (e.g., “ ”, “Chat between John and Mark”).
Topic confidences: List of topics with corresponding base and calculated confidence metrics. A “base” confidence metric, as used here, is a topic confidence metric 251 which is specific to the existing information source 220 providing the piece of content 240; whereas a “calculated confidence metric” is a confidence metric calculated based on several existing information sources 220 as will be described below.

A concrete example of information stored in relation to an existing piece of content 240 is the following, where again any textual information can be stored in plaintext, encoded, compressed and/or vectorized format:

```
{
  ″Content ID″: 1,
  ″Source ID″: “user_1234”,
  ″Content″: ″Mark: What do you like to eat?\nJohn: I like Pizza.″,
  ″Context″: ″Chat between John and Mark″,
  ″Topic confidences″: [
    {″Topic″: ″user_1234″, ″Base″: 1, ″Calculated″: 1},
    {″Topic″: ″pizza″, ″Base″: 0.9, ″Calculated″: 0.9}
  ]
}
```

In a subsequent step S103, a first piece of content 241 is received by the central server 130, such as from any one of entities 120, 121. The first piece of content 241 can be of the same general form as, or formatted/transformed into the same general form as, the existing pieces of content 240, and is associated with a first information source 211 being an originator or provider of the first piece of content 241. In particular, the first piece of content 241 can be or comprise unstructured information, such as in the form of text. The first piece of information 241 can be, or be transformed by the central server 130, into plaintext information. The first information source 211 can be of the same general form as, or formatted/transformed into the same general form as, the existing sources 210. The first information source 211 can also be one of the existing information sources 210.

In general, the existing set of information 200, and in particular the existing pieces of content 240, can be conflict-resolved in the sense that all contradictory information is associated with a corresponding confidence metric arranged to measure a trustworthiness or truthfulness of the information in question. In other words, in case two pieces of information in the existing pieces of content 240 are contradictory, the existing set of information 200 contains information regarding what is a likely resolution to that contradiction. This can be done using the confidence metrics 251 for the pieces of content 240 in relation to topics to which the respective pieces of content 240 relate. As will be described below, these confidence metrics 251 can be used to determine the credibility of individual pieces of content 240, such as individual statements about the world, taking into account any conflicting views expressed in the totality of the pieces of content 240 in the set of information 200.

Further generally, the union of the existing set of information 200 and the first piece of content 214, and in particular the union of the existing pieces of content 240 and the first piece of content 241, as the first piece of content 241 is not necessarily conflict-resolved in said sense.

In practical examples, a content ingest data structure can be formed describing the first piece of content 241 in its capacity of new information to be added to the set of information 200. The data structure can, for instance, comprise one or several of the following fields:
Source: The origin information source (the first information source 211) of the data entry (the first piece of content 241) (e.g., “User John”). This helps in determining the trustworthiness of the information.
Content: The actual data entry (the first piece of content 241) that is to be processed and stored (e.g., “Mark: What do you like to eat?\nJohn: I like Pizza”).
Additional_context: Any extra context that provides more details or background information about the content (e.g., “A chat between John and Mark”).

The following is a concrete example, where again any textual information can be stored in plaintext, encoded, compressed and/or vectorized format:

```
{
  ″Source″: ″user_1234”
  ″Content″: ″Mark: What do you like to eat?\nJohn: I like Pizza.″,
  ″Additional_context″: ″A chat between John and Mark″
}
```

In an example, Mark and John, that each individually can be a participant 122, are having a conversation over a chat application, for instance being a part of a video communication service provided by server 180. An automated bot, such as the autonomous entity 125, monitors this conversation and continuously or intermittently uploads corresponding chat logs to the central server 130 for processing. The goal is to parse the contents of the chat, to identify topics, and to store an iteratively and incrementally updated view of the conflict-resolved information. The processing flow can comprise the use of LLM processing, as will be described below, possibly in combination with vector lookup (using vectorized data representations of the above discussed type), and handling both existing topics 220 and the creation of one or several new provisional topics.

The following is the chat conversation between Mark and John:
Mark: “Hey John, what do you like to eat?”
John: “I like Pizza. I also enjoy trying new dishes.”
Mark: “Have you ever tried Sushi?”
John: “No, I haven't, but I'm willing to try it sometime.”

The bot 125 is configured to monitor the chat conversation in real-time. It captures the chat log, including any relevant metadata such as the participants' 122 identities and relevant timestamps for the chat entries. The bot 125 then uploads the captured data to the central server 130 in a structured format. The following is an example of the uploaded data:

```
{
  “Source”: “ChatBot”,
  “Content”: “Mark: Hey John, what do you like to eat?\nJohn: I like
  Pizza. I also enjoy trying new dishes.\nMark: Have you ever tried
  Sushi?\nJohn: No, I haven't, but I'm willing to try it sometime.”,
  “Additional_context”: “Chat between Mark and John”
}
```

The central server 130 can use a predetermined data format, such as the content ingest data structure described above, for ingesting the first piece of content 141 into the existing set of information 200. As used herein, the term “ingest” means processing the existing set of information 200 as described herein and in dependence of the first piece of content 141 to modify the existing set of information 200 to be conflict-resolved in the sense discussed above.

In some embodiments, such as when the first piece of content 241 is larger than a predetermined threshold size, the method can comprise, in a step S104, splitting the first piece of content 241 into two or more separate pieces of content 243. For instance, in the present example the content “Mark: Hey John, what do you like to eat?\nJohn: I like Pizza. I also enjoy trying new dishes. \nMark: Have you ever tried Sushi?\nJohn: No, I haven't, but I'm willing to try it sometime.” has a larger size than the predetermined threshold size, and is therefore split into two separate parts according to the following:
Part 1: “Mark: Hey John, what do you like to eat?\nJohn: I like Pizza. I also enjoy trying new dishes. \nMark: Have you ever tried Sushi?”
Part 2: “John: I like Pizza. I also enjoy trying new dishes. \nMark: Have you ever tried Sushi?\nJohn: No, I haven't, but I'm willing to try it sometime.”

As is illustrated in this example, the splitting of the first piece of content 241 into two or more separate pieces of content 243 can be configured to result in a partial overlap between the two or more separate pieces of content 243 (parts 1 and 2 above).

In various embodiments, the predetermined threshold size can be more than five words and/or at the most one hundred words. In various embodiments, the predetermined threshold size can be more than twenty bytes and/or at the most one thousand bytes.

Then, each of the two or more separate pieces of content 243 can be used the first piece of content 241, to be processed serially or in parallel.

In the present example, the split into the several separate pieces of content 243 is done by conversation lines, but it is realized that many other methods can be selected, including token length, words, or even pure character limits. It is especially pointed out that the split can take place without considering any cognitive contents of the first piece of information 241, and in particular without considering any cognitive or informational connection to the already existing set of information 200. Since the presently described methodologies have been found to yield satisfactory results without such considerations, performing the split in this manner achieves more efficient processing of the information.

It is realized that the first piece of content 241 can be received together with context information, comprising one or several of an information source of the first piece of content 241 (the first data source 211); additional context; and any additional associated information which is relevant to the first piece of content 241. The additional context and/or any additional associated information can be unstructured information, such as text. The first information source 211 can be a name of an information source, which is then interpreted by the central server 130 and mapped to one of the existing information sources 210 (or used to create a new information source reference to be added to the existing information sources 210); or it can be a reference directly into the set of existing information sources 210.

Generally, the autonomous entity 125 can be configured to continuously read an available alphanumeric stream 300 of information, which for instance can be said chat communication or other text-based communication involving at least two participants 120; or a transcript of a non-text communication involving the at least two participants 120. Then, the autonomous entity 125 can be configured to parse or split the alphanumeric stream 300 of information into a sequence of separate pieces of content 243 and use the sequence of separate pieces of content 243 as consecutive first pieces of content 241.

Further generally, each participant 120 can be noted as an information source 210 (the first information source 211) for each communication message produced by that participant 120.

In such and other embodiments, at least one of the at least two participants 120 is an automated communication bot 125 of the described type.

The result after this splitting and formatting the first piece of content 241 is shown below in an example, spanning across two ingestion data structures used for further processing:

```
Dataset 1:
{
  “Source”: “ChatBot”,
  “Content”: “Mark: Hey John, what do you like to eat?\nJohn: I like
Pizza. I also enjoy trying new dishes.\nMark: Have you ever tried Sushi?”,
  “Additional_context”: “Chat between Mark and John”
}
Dataset 2:
{
  “Source”: “ChatBot”,
  “Content”: “John: I like Pizza. I also enjoy trying new dishes.\nMark:
Have you ever tried Sushi?\nJohn: No, I haven't, but I'm willing to try it
sometime.”,
  “Additional_context”: “Chat between Mark and John”
}
```

As can be seen from Dataset 1 and Dataset 2 above, in practice there can be more than one first information source 211 in the first piece of content 241, in addition to the explicitly stated information source “ChatBot”. Namely, in Dataset 1, John talks about his own preferences in terms of pizza and trying new dishes. In Dataset 2, Johan talks about his own preferences in terms of trying new dishes, and in particular sushi; as well as the fact that he has never had sushi.

The central server 130 can be configured to, in a step S105, analyze the first piece of content 241 to identify any information sources for the information in the first piece of content 241. This analysis can take place by constructing a textual prompt to this end; to feed the prompt to the first LLM 150 (or to a different LLM), the prompt requesting the LLM in question to respond with any information sources referred to or mentioned in the first piece of information 241 and being information sources for information contained in the first piece of information 241. For instance, the prompt can instruct the LLM in question to respond with a list of any such information sources.

In an example, the central server 130 is configured to send the following prompt to the first LLM 150: “In the following text forming part of a chat between Mark and John, identify any information sources to any information contained in the text, but do not count the chat engine itself and limit the response to a simple enumeration of any information sources: Mark: Hey John, what do you like to eat?\nJohn: I like Pizza. I also enjoy trying new dishes. \nMark: Have you ever tried Sushi?”. The response from the first LLM 150 may then be “John”.

Then, given such an expanded list of information sources for the first piece of content 241 in relation to each of the available content subsets (after any splitting), the content ingestion datasets can be expanded according to the following:

```
Dataset 1:
{
  “Source”: “ChatBot”,
  “Content”: “Mark: Hey John, what do you like to eat?\nJohn: I like
Pizza. I also enjoy trying new dishes.\nMark: Have you ever tried
Sushi?”,
  “Additional_context”: “Chat between Mark and John”
}
Dataset 2:
{
  “Source”: “John”,
  “Content”: “John: I like Pizza. I also enjoy trying new dishes.\nMark:
Have you ever tried Sushi?\nJohn: No, I haven't, but I'm willing to try
it sometime.”,
  “Additional_context”: “Chat between Mark and John”
}
Dataset 3:
{
  “Source”: “ChatBot”,
  “Content”: “Mark: Hey John, what do you like to eat?\nJohn: I like
Pizza. I also enjoy trying new dishes.\nMark: Have you ever tried
Sushi?”,
  “Additional_context”: “Chat between Mark and John”
}
Dataset 4:
{
  “Source”: “John”,
  “Content”: “John: I like Pizza. I also enjoy trying new dishes.\nMark:
Have you ever tried Sushi?\nJohn: No, I haven't, but I'm willing to try
it sometime.”,
  “Additional_context”: “Chat between Mark and John”
}
```

Alternatively, the central server 130 can be configured to include more than one information source into each content ingest dataset of the above exemplified type.

It is noted that Mark is not an information source in this case, since Mark does not provide any information apart from posing the questions in the chat.

For identified first information sources 211 that are already part of the existing information sources 210, any information stored in relation to each of that information can be read from the existing information sources 210. This read information can then provide information regarding base confidence metrics and information source behavior configuration, such as the information source's capability to create provisional topics and similar. On the other hand, in case a first information source 211 is not previously known to the central server 130, default values for base confidence metrics, capability to create provisional topics and so forth can be used. In some embodiments, the system 100 can be configured to allow manual curation of newly added information sources by a system 100 operator. In some other embodiments, the central server 130 is configured to ignore first information sources 211 that do not map onto one of the existing information sources 210, possibly leading to information from such unknown first information sources 211 to be ignored.

In a subsequent step S106, a set of one or several potential topics 223 can be identified in the first piece of content 241. In various embodiments, this identifying is performed based on the set of existing topics 220 in the information 200. For example, the set of potential topics 223 can be identified as a second subset 247 of the set of existing topics 220.

The identification of the set of one or several potential topics 223 can take place using a simple identity or similarity search or mapping, involving individual subparts of the first piece of contents 241 in relation to each of the set of existing topics 220. In one example, the first piece of content 241 as well as the set of existing topics 220 are, or correspond to, textual pieces of information, and an identity or similarity search is performed according to some per se conventional and suitable algorithm in order to identify all existing topics 220 that occur verbatim or almost verbatim, according to a suitable distance metric formulated in terms of number of identical characters or similar, in the set of existing topics 223. Such search or mapping can take place using plaintext data.

However, as mentioned above the set of existing topics 220 can be stored in a vectorized format, and then the set of potential topics 223 can be identified in the vector space as all of the existing topics 220 that are located sufficiently close, according to a geometric distance metric, to a vector representation of the first piece of information 241 and/or to one or several of respective vector representations of subparts of the first piece of information 241.

Continuing the above example, a vector-space search can be performed on the set of existing topics 220 to find the topics most closely related to the first piece of content 241. This search can also produce a respective similarity score for each of the identified topics.

The search can be performed using vector-space comparisons to produce the following exemplary data structure, where the “similarity_score” is a suitable geometric distance measure in vector space and wherein the list can be calculated as a sorted list of all existing topics 220 having a “similarity_score” above a predetermined threshold:

```
{
  ″Topics″: [
    {″topic_id″: ″user_1234″, “name”: “John”, ″similarity_score″:
    0.95},
    {″topic_id″: ″user_42″, “name”: “Mark”, ″similarity_score″: 0.95},
    {″topic_id ″: ″pizza″, “name”: “Pizza”, ″similarity_score″: 0.90},
    {″topic_id ″: ″sushi″, “name”: “Sushi”, ″similarity_score″: 0.80}
  ]
}
```

When comparing a topic 220 to a piece of content 240, both are embedded into respective vector representations, for instance using a neural network or transformer-based model (like BERT or GPT). More particularly, the piece of content 240 can be tokenized (parsed into a set of consecutive tokens together forming the piece of content 240), and each of the resulting tokens can be converted into a respective vector that then captures semantic information based on context in the set of tokens. These resulting token vectors can then be combined into a single vector representing the overall semantic content. In this combination, mechanisms such as self-attention and positional encoding can be used to take into consideration semantic context and word order. Similarly, each topic 220 can also be also embedded as a respective vector, then without taking any particular context, apart from the topic itself, into consideration.

To compare the vectors for the piece of content 240 and the topic 220, cosine similarity (or another distance metric like Euclidean distance) can be used to measure how closely aligned the content vector is with each of the topic vectors. A similarity score above a set threshold (e.g., 0.8) can be used to signify that the topic 220 is deemed relevant. This allows for identifying related topics 220 in the piece of content 240 with precision based on their vector closeness.

Then, in a subsequent step S107, a first prompt can be produced and provided to the first neural network or LLM 150. The first prompt can be configured to request the first neural network or LLM to provide a list or set 221 of identified topics 222 that are actually addressed in the first piece of content 241 (or each of the pieces of content 243 if the first piece of content 241 was split). In a subsequent step S108, a corresponding response (a first piece of response information) is received from the first neural network or LLM 150. The first response comprises the set 221 of identified topics 222. As used herein, the term “actually addressed” means that the identified topics 222 not merely occur or are mentioned in the first piece of content 241, but that something is materially stated about the identified topics 222 in the first piece of content 241.

It is thus noted that the first prompt can be constructed so as to produce, in a response from the first neural network or LLM 150, information regarding topics that are actually addressed in, not merely mentioned or referred to, the first piece of content 241. The identified topics 222 can, in some embodiments, be restricted to (form a subset of) the set of existing topics 220. In other embodiments, identified topics 222 that are not found in the set of existing topics 220 can be used to form new topics for addition to the set of existing topics 220 in subsequent iterations of the method.

As an alternative or supplement to filtering out the identified topics 222 that are actually addressed in the first piece of content 241, a set of the most relevant ones of the identified topics 222 can be selected for use in the later steps of the method. The “most relevant ones” can be selected according to any suitable predetermined criterion, such as being closest, in vector space, to the first piece of content 241.

In a practical example, the first prompt is the following: “Given the content: ‘Mark: Hey John, what do you like to eat?\nJohn: I like Pizza. I also enjoy trying new dishes. \nMark: Have you ever tried Sushi?’ and the topics: [John, Pizza, Sushi, Mark], extract any relevant topics being discussed in the content. If a content is present, but not a topic for discussion, do not include it in the list.” As illustrated by this example, the prompt can comprise or refer to the one or several potential topics 223 identified as described above, based on the first piece of content 241, and urge the first neural network or LLM 150 to ascertain which one(s) of these potential topics that are actually addressed or discussed in the first piece of content 241.

In FIG. 4b, it can be seen that the first piece of content 241, coming from the first information source 211, is split into two separate but overlapping parts 243. The parts 243 contain (with sufficient similarity according to a particular sufficiency measure being used) five different potential topics 223, each forming part of the existing topics 220. One of the topics 223 is contained in both parts 243. Of the set of five potential topics 223, a list or set 221 of three identified topics 222 are identified as actually being addressed in the first piece of content 241. Hence, the first prompt contains, in this and other examples, the set of potential topics 223 or a reference to this set, and instructs the first LLM 150 to provide the identified topics 222 as a subset of zero, one, several or all of the potential topics 223.

The response from the first LLM 150, to the first prompt, can be “John, Pizza, Sushi”. This response can be readily transformed into the following data structure that can then be used for data ingestion into the set of information 200:

{
“topics”: [“user_1234”, “pizza”, “sushi”]
}

It is noted that “Mark” is not discussed in the first piece of content 241, but merely occur as a contributor to the chat. Therefore, the first neural network or LLM 150 does not include “Mark” in the returned list.

For each of the identified topics 222, a processing can then take place affecting the set of information 200. In particular, the respective existing topic 220 corresponding to (such as identical to or sufficiently similar according to a predetermined closeness measure, such as in vector space) each identified topic 222 can be identified. If no such existing topic 220 exists, a new topic can be constructed and added to the existing topics 220, possibly using default parameters and associations 230 for the new topic. Correspondingly, the existing information source 210 corresponding to (or being sufficiently similar according to a predetermined closeness measure) the first information source 211 can be identified (or constructed if not already existed, possibly using default parameters). Then, the association 230 between the existing topic 220 and the existing information source 210 can be inspected, and the corresponding existing source confidence metric 232 can be read.

In various embodiments, the corresponding existing source confidence metric 232 can be used to update a topic confidence metric 251 stored by the central server 130 as a part of, or in association to, an association 250 between the first piece of content 241 (or correspondingly a split-up piece of content 243 of the above-described type) and the topic 220. In other words, the association 250 between, firstly, the first piece of content 241 or 243 and, secondly, the topic 220, can be updated based on the source confidence metric 232 between the topic 220 and the first information source 211. It is noted that the first piece of information 241 or 243 in this situation forms part of the existing pieces of content 240, and that the information source 211 forms part of the existing information sources 210. Since the first information source 211 is mapped onto the existing information source 210 and since the first piece of content 241 or 243 is mapped onto the existing piece of content 240, the set of information 200 is incrementally updated based on the likely truthfulness or credibility of the information contained in the existing pieces of content 240. This updating can include at least an updating of the relevant topic confidence metrics 251.

Hence, in a step S109 the first piece of content 241 can be stored, in the one or several databases 140, in referenced or actual format. The first piece of content 241 is associated with one or several identified topics 222 in the list or set 221 of identified topics 222. Furthermore in step S109, for each of the one or several identified topics 222 in the list or set 221 of identified topics 222, a corresponding respective first topic confidence metric 252 for the combination of the first piece of content 241 and the identified topic 222 can be stored or updated.

In the following example, a data ingest structure is produced having processing status “unprocessed” with respect to each identified topic 222. The central server 130 can be configured to perform the below-described conflict resolution immediately or later, for instance depending on time requirements, optimization configuration settings, the type of topic, topics required for analysis of incoming queries or requests, and so forth. Once the conflict resolution has been performed, the status can be changed to “processed” or similar.

Hence, for each identified topic 222, the corresponding information source's 210 link table entry is looked up to determine the base confidence metric 232, and the entry status can be set to “unprocessed”. The following is then an example of the resulting data ingest structure for dataset 1 above:

```
{
  “Source ID”: “ChatBot”,
  “Content”: “Mark: Hey John, what do you like to eat?\nJohn: I like
  Pizza. I also enjoy trying new dishes.\nMark: Have you ever tried
  Sushi?”,
  “Context”: “Chat between Mark and John”,
  “Topic Confidences”: [
    {“Topic”: “user_1234”, “Confidence”: 1, “Status”: “unprocessed”},
    {“ Topic ”: “pizza”, “Confidence”: 0.6, “Status”: “unprocessed”},
    {“ Topic t”: “sushi”, “Confidence”: 0.6, “Status”: “unprocessed”}
  ]
}
```

Here, “Confidence” is the topic confidence metric in question.

This data ingest structure can then be saved into the memory 140, or be used to update corresponding information in the memory 140 to reflect the changes.

As mentioned above, there are times when new data being added to the set of information 200 will directly conflict with existing data in the set of information 200, and in particular the existing pieces of content 240 may conflict with the added first piece of content 241 or 243. In such cases, the method can comprise adjusting the topic confidence metrics 251, allowing the subsequent determination of the accuracy of each piece of content 240 including any statements made in the pieces of content 240. This can comprise comparing all or a subset of the existing pieces of content 240 to each added first piece of content 241 or 243 to identify conflicts. However, in various embodiments the comparison can be limited to existing pieces of content 240 that relate to the identified topics 222.

Since the potential size of the set of information 200 is huge, the option to delay this processing until later, via the status of “unprocessed”, can be used. Generally speaking, the determining of the first topic confidence metric 252 for the combination of the first piece of content 241 and the identified topic 222 can be performed at a later point in time, after a second (subsequent or preceding) piece of content 244 has been received and processed as the first piece of content 241. Alternatively, the data can be processed immediately.

Steps S110 and forwards, that will be described in the following, can be performed, immediately or with a delay, simultaneously or at different times, in parallel or in series, for each of the one or several identified topics 222 of the list or set 221 of identified topics 222.

In step S110, that can be performed before or after step S109 for the identified topic 222 in question, a first subset 246 of the existing pieces of content 240 is identified. The first subset 246 is identified as those existing pieces of content 240 that are related to the identified topic 222 in question.

The first subset 246 of the existing pieces of content 240 can be identified in various ways.

In a first example, a similarity search is used, between a vectorized form of the identified topic 222 in question and respective vectorized forms each of the set of existing pieces of content 240. For instance, for the identified topic 222 “pizza”, a geometric distance measure in the vector space can be used to find all existing pieces of content 240 the vector representation of which are sufficiently close to a vector representation of the word “pizza”. In a concrete example, a cosine similarity measure or Euclidean distance metric in the vector space can be used to compare the vector representation of the word ‘pizza’ with the vector representations of all existing pieces of content 240. The central server 130 can be configured to identify pieces of content 240 where the vector distance is below a set threshold, meaning their vector representations are sufficiently close to that of the word ‘pizza.’ This indicates a high level of semantic similarity between the word ‘pizza’ and the relevant pieces of content. Self-attention can be used when calculating the vector representation of the piece of content 240, which in general will result in geometric proximity between pieces of content 240 and relevant topics 220 in vector space.

In a second example, the first subset 246 is identified using a text search, between a plaintext form of the identified topic 222 and respective plaintext forms of the set of existing pieces of content 240. Such text search can be based on exact matches or allow for a certain discrepancy between the topic 222 and the pieces of content 240, for instance by allowing one or several characters to differ or by ignoring word endings, and so forth.

The first subset 246 can also be identified using prompting an LLM, but in various embodiments it is performed without involving an LLM.

Thereafter, it is determined if the first piece of content 241 or 243 containing or otherwise being associated with the identified topic 222 conflicts with, supports or is unrelated to each individual ones of the existing pieces of content 240 in the first subset 246 of topics.

Hence, in a subsequent step S111 a second prompt is provided to the first neural network or LLM 150 or to the second neural network or LLM 160. The second prompt can be configured to request the neural network or LLM 150 or 160 in question to provide information regarding if the first piece of content 241 supports, contradicts or is neutral in relation to each of one or several, such as all, of the first subset 246 of the existing pieces of content 240.

It is noted that the first subset 246 of existing pieces of content 240 will typically not be all the existing pieces of content 240, or even more than a small fraction of the existing pieces of content 240. Hence, in case an LLM 150 or 160 used has a limited attention space this will normally not be a problem. In case the first subset 246 is too large to fit into the attention space of the used LLM 150 or 160, the second prompt can be divided into several separate second prompts that are used and processed in the corresponding manner, in parallel or series, each of the several second prompts comprising different parts of the subset 246. In some embodiment, an individual second prompt is provided for each existing piece of content 240 in the first subset 246, only querying about support/contradiction for one single such piece of content 240 per second prompt.

In a simple example, the first piece of content 141 is “John likes Pizza.”, and the subset 246 of existing pieces of content 240 are the following:
“John loves Pizza.” The corresponding source confidence metric 232 for the topic 220 “pizza” and this piece of content has previously been determined to be 0.9.
“John hates Pizza.” The corresponding source confidence metric 232 is 0.6.
“John likes ice cream.” The corresponding source confidence metric 232 is 0.6.

The second prompt can, as an example, read according to the following: “Given the content: ‘John likes Pizza.’ and the existing entries: [‘John loves Pizza.’; ‘John hates Pizza.’; ‘John likes ice cream.’], determine, for each entry in the list if the entry supports, conflicts with, or has no relation to the content. Respond using a list having the same format as the list of existing entries, but indicating each relation as a respective additional data entry using comma separation.”

In a subsequent step S112, a response is received from the used LLM 150 or 160. For instance, the response can be “[‘John loves Pizza.’, supports; ‘John hates Pizza.’, conflicts; ‘John likes ice cream.’, no relation]”.

Hence, in a response from the first or second neural network of LLM 150 or 160, a second piece of response information can be received, the second piece of response information indicating that the first piece of content 241 contradicts one or several particular existing pieces of content 242 of the first subset 246 of existing pieces of content 240. Hence, the particular pieces of content 242 can be those existing pieces of content 240 that, firstly, relate to the identified topic 222 and, secondly, contradicts the identified topic 222; supports or contradicts the identified topic 222; is not unrelated to the identified topic 222.

After purging the “no relation” pieces of content 240, the following set of information results, in the present example:
Supports: “John loves Pizza.” (source confidence metric: 0.9)
Conflicts: “John hates Pizza.” (source confidence metric: 0.6)

In a subsequent step S113, the first topic confidence metric 252 is determined and saved as a new or updated corresponding topic confidence metric 251 in the set of information 200.

More particularly, the first topic confidence metric 252 can be determined based on a source confidence metric 253, corresponding to or comprised in the source confidences 232, between the first information source 211 (corresponding to or being an existing information source 210) and the identified topic 222 (corresponding to or being an existing topic 220).

Furthermore, the first topic confidence metric 252 can be determined also based on an existing topic confidence metric 254, comprised in the topic confidence metrics 251, for the identified topic 222 in relation to respective each of the particular pieces of content 242. Hence, in the general case there will be one such topic confidence metric 254 for each of the identified particular pieces of content 242, and the first topic confidence metric 252 is determined based on at least one, such as several or even all of these topic confidence metrics 254.

It is noted that the source confidence metric 253 and the topic confidence metrics 254 are generally known. In case the first information source 211 does not already exists in the set of information 200, it can be added, and a default value can be used for the source confidence metric 253.

Reiterating the above example, it is assumed that the participant 122 John makes an entry into the client 121 of “John likes pizza”, which text is then the first piece of content 141. Two different potential topics 223, namely “John” and “pizza” are identified in the first piece of content 141. The word “likes” does not correspond to any of the existing topics 220, and since it is a verb (or using any other suitable selection rule) the central server 130 is configured to not create a new topic for the word “likes”. For both of these potential topics 223, it is established that they each actually are addressed in the first piece of content 241, and hence together form the set 221 of identified topics 222.

For each of the identified topics 222 “John” and “pizza”, a respective source confidence metric 253 for existing information source 210 “John” is either fetched from the existing source confidence ratings 232 or established. In this exemplary embodiment, each source confidence metric 253 is as a floating point number between values 0 (false) and 1 (true).

Since the topic “John” already exists as a topic 220 in the set of information 200, and that the primary source or topic “John” is indicated in the set of information 200 as participant 122 “John”, the source confidence metric 253 for topic “John” is 1. The procedure above is unable to find any existing pieces of content 240 that relate to topic “John” and that contradict (or supports) the first piece of content 141. Therefore, the first topic confidence metric 252 is determined to be 1, which number is stored in the set of information 200 as the corresponding topic confidence metric 252.

Next, the procedure is reiterated but now with identified topic 222 “pizza”. In this example, “pizza” is not among the existing topics 220 in the set of information 200, so it is created. Since the relation between “John” as the first information source 211 and “pizza” as a topic is not known, “pizza” is constructed as a “provisional” topic meaning that no particular information source 210 is listed as more credible (better source confidence metric 232) than any other information source 210. In this case, this is due to the fact that no existing pieces of content 240 so far relate to the topic 220 “pizza” in the set of information 200. Such “provisional” status can be maintained, for instance, until a sufficiently credible (such as primary) information source is identified by the central server 130, until an operator marks the topic as “non-provisional” and so forth. In the case in which different topics 220 are associated with individual access rights, the “provisional” topic of “pizza” is also listed as generally accessible. The source confidence metric for topic “pizza” in relation to information source “John” can, for instance, be calculated based on an average of source confidence metrics 253 for all other non-provisional identified topics 222 in the first piece of content 241 or 243, for instance a value being proportional to such average using a predetermined factor. In this case, the only such identified topic 222 is “John”, having a source confidence metric of 1 according to the above. In this example, a proportionality factor of 0.9 is used, so the source confidence metric 253 for topic “pizza” in relation to information source “John” is set to 0.9 times 1=0.9.

The first piece of content 241 “John likes pizza” is added to the set of information 200 as an existing piece of content 240, being associated with topics “John” (topic confidence metric=1) and “pizza” (topic confidence metric=0.9).

The next thing that happens in this example is that participant 122 Sally writes in the chat “John likes pineapple on his pizza”. Again, the two subjects “John” and “pizza” can be identified. Topic “pineapple” is also identified, but this is ignored here for reasons of brevity.

Sally is not the primary source of truth for the topic “John”. However, Sally is listed in the set of information 200 as a secondary source of truth for topic “John”, since the central server 130 has been previously configured this way since Sally is a colleague of John's. Since Sally is a registered secondary source of truth for John, the central server 130 can infer that the statement that Sally makes regarding topic “John” can be assigned a topic confidence metric of 0.8 (or any other predetermined confidence metric for this situation).

The existing piece of content 241 “John likes pizza” is identified as the single particular piece of content 242 for both topics “John” and “pizza”. “John likes pizza” is found to support “John likes pineapple on his pizza”.

The result is then that the first piece of content 241 “John likes pineapple on his pizza” is added to the set of information 200 as an existing piece of content 240 having topic confidence level 0.8 in relation to topic “John” and topic confidence level 0.72 in relation to topic “pizza”. 0.72 is calculated as existing topic confidence metric for topic “pizza” in relation to the particular piece of content 242 “John likes pizza” times the source confidence metric for source “Sally” in relation to topic “pizza”=0.9 times 0.8=0.72.

Next, participant Frank 122 writes into the chat “John hates Pizza”. Frank is not registered in the central server 130 as any particular type of source of truth for the topic “John”, why the central server 130 is configured to assign an initial source confidence metric to this combination of 0.6, meaning that the validity of this data in unclear, but perhaps leans slightly towards truth. Again, the parameter value 0.6 can be predetermined to cater for this situation and is merely an example in this case.

During the processing of this new first piece of content 241 “John hates pizza”, the central server 130 will find the existing piece of content 240 “John likes pizza”, being identified as contradicting “John hates pizza” and having the topic confidence metric in relation to topic “John” of 1. The topic confidence metric for “John hates pizza” in relation to topic “John” is then calculated based on the existing topic confidence metric 1, and also taking into consideration the existing topic confidence metric 251 of the conflicting existing piece of content 240 “John likes pizza” and the source confidence metric 253 for the first source “Frank”. As an example, the source confidence metric 253 can be multiplied by the difference between the two topic confidence metrics for the conflicting pieces of content. Hence, (1−1)*0.6=0*0.6=0. As can be seen, the topic confidence metric 252 is set to 0, effectively meaning “false”. This result is due to the fact that source “John” is the primary source of truth for topic “John”, and what source “Frank” contributes in relation to this topic will not be allowed to affect the trustworthiness of whatever “John” has provided to this end.

Now, participant 122 James writes in the chat “John doesn't like pineapple on his pizza”. James, again, is not registered as any particular source of truth for topic “John”. The situation is then the same as above with participant 122 Frank, but the first piece of content “John doesn't like pineapple on his pizza” is detected to conflict with Sally's statement “John likes pineapple on his pizza”. As a result, the first piece of content provided by James is stored in the set of information 200 as an existing piece of content having a topic confidence metric of (1−0.8)*0.6=0.12. 0.12 is lower than 0.5 but higher than 0, signifying “likely false”.

If information source 210 “James” had also been registered by the central server 130 as a secondary source of truth for topic “John”, the situation would be different. In this case, the topic confidence metrics for topic “John” in relation to the conflicting piece of content “John likes pineapple on his pizza” and “John doesn't like pineapple on his pizza” are the same, namely 0.8. In this case, the respective topic confidence levels 251 of all conflicting existing pieces of content 240, or at least of all conflicting existing pieces of content 240 having the same respective topic confidence levels 251, can be updated as a result of the processing of the first piece of content 241. In this example, a multiplier is created by the central server 130 for all conflicting pieces of content 240, and all corresponding topic confidence levels 251 are updated. In this particular case and example, there are only two conflicting pieces of content 240, so the topic confidence level 251 of 0.8 can be split in two to yield an updated topic confidence level of 0.8/2=0.4 for each. More generally, in case there are x pieces of content 140 that support the first piece of content 141 and y pieces of content 140 that conflict with the first piece of content 141, the topic confidence metrics 251 for the supporting topics can be scaled by x/y, or any other function of x and y that results in an improved topic confidence metric 251 for increasing values of x; and the topic confidence metrics 251 for the conflicting topics can be scaled by y/x, or any other function of x and y that results in an improved topic confidence metric 251 for increasing values of y. Instead of x/y and y/x, linear functions of x and y can be used.

It is understood that the above discussion about the chat between John, Mark, Sally and James is provided for illustration and as an example. In the general case, the respective topic confidence metrics 251 for each of the pieces of content 240 detected to be conflicting and/or supporting each other in various ways, including the first topic confidence metric 252 of the first piece of content 240 or 243 in relation to each identified topic 222, can be updated in reaction to the addition of the first piece of content 240 or 243 to the set of information 200. How this updating takes place can vary depending on the detailed prerequisites and aims, but in general topic confidence metrics 251 of conflicting pieces of content 240 will stay the same or be worsened (such as decreased) in response to detection of such a conflict and/or topic confidence metrics 251 of supporting pieces of content 240 will stay the same or be improved (such as increased) in response to detection of such a support.

In general, to manage conflicting pieces of content 240 via calculation of updated topic confidence metrics 251, 252, different types of equations can be used, such as calculated based on topic confidence metrics 251 from different information sources 210 as exemplified above.

In the following, a number of different possible alternatives will be explained, as examples.

In a first example, the determining of the first topic confidence metric 252 is performed by multiplying the first source confidence metric 253 with a function of a negated value of the existing topic confidence metric 254.

In this case, the equation used can be: (1−topic confidence metric 255 of conflicting piece of content 242)*first source confidence metric 253. This equation helps to adjust the confidence level of a data entry based on conflicting information. It ensures that a confidence score of 1 remains unaffected and a confidence score of 0 remains unchanged.

In case the existing piece of content 242 “John likes Pizza” has an existing topic confidence metric 254 of 1 and the first piece of content 241 “John hates Pizza” has the first source confidence metric 253 of 0.6, the adjusted first topic confidence metric 252 for the first piece of content 241 “John hates pizza” becomes (1−1)*0.6=0*0.6=0.

In a second example, the determining of the first topic confidence metric 252 is performed by forming a weighted average or geometric mean of the first source confidence metric 253 and the existing topic confidence metric(s) 254, and using the weighted average or geometric to determine the first topic confidence metric 252.

In this case, the equation used can be (first source confidence metric 253*weight1+existing topic confidence metric 254 #1*weight2+existing topic confidence metric 254 #2*weight3+[ . . . ])/(weight1+weight2+weight3+[ . . . ]). This equation calculates the weighted average of multiple confidence scores. Weights can be assigned, for instance, to be equal or based on preset reliability of the information sources 210, 211.

If the existing piece of content 242 “John likes Pizza” has an existing topic confidence metric 254 of 0.8 with weight 2, and the first piece of content “John hates Pizza” has a first source confidence metric 253 of 0.4 with weight 1, the adjusted first topic confidence metric 252 using a weighted average mean becomes (0.8*2+0.4*1)/(2+1)=(1.6+0.4)/3=2/3≈0.67.

Similarly using a geometric mean method, the equation becomes (first source confidence metric 253+existing topic confidence metric 254 #1+existing topic confidence metric 254 #2+ [ . . . ])/(1\hat{ }n), calculating the mean of multiple confidence metrics while providing a balance between low and high values. If “John likes pizza” has an existing topic confidence metric 254 of 0.9 and “John hates pizza” has a first source confidence metric 253 of 0.6, the adjusted first topic confidence metric 252 becomes (0.9*0.6)\hat{ }0.5=0.54\hat{ }0.5≈0.73.

In a third example, the determining of the first topic confidence metric 252 is performed using a Bayesian statistic model. The equation can be (existing topic confidence metric 254*first source confidence metric 253)/(existing topic confidence metric 254*first source confidence metric 253+(1−existing topic confidence metric 254)*(1−first source confidence metric 253)). This method updates the prior confidence level (the existing topic confidence metric 254) based on new evidence (the first source confidence metric 253). It is useful for sequentially updating confidence levels as new data comes in.

If the existing topic confidence metric 254 for “John likes Pizza” is 0.7 and the first source confidence metric 253 is 0.8, the adjusted first topic confidence metric 252 becomes (0.7*0.8)/(0.7*0.8+(1−0.7)*(1−0.8))=0.56/(0.56+0.06)=0.56/0.62≈0.90.

In a fourth example, the determining of the first topic confidence metric 252 is performed using a maximum likelihood model. The equation can be max (first source confidence metric 253, existing topic confidence metric 254 #1, existing topic confidence metric 254 #2, [ . . . ]). This method takes the highest confidence score among multiple entries, assuming the most confident source is the most reliable.

If “John likes Pizza” has an existing topic confidence metric of 0.85 and “John hates Pizza” has a first source confidence metric of 0.65, the adjusted first topic confidence metric 252 becomes max (0.85, 0.65)=0.85.

In a fifth example, the determining of the first topic confidence metric 252 is performed using a neural network, such as the first, second or third neural networks or LLMs 150, 160, 170, the neural network then being trained on historic information regarding adjustments of source confidence metrics 232 and/or topic confidence metrics 251.

In all these examples, the first topic confidence metric 252 is calculated based on at least one existing topic confidence metric 251. It is, however, realized that, in addition, at least one, several or all of the existing topic confidence metrics 254 can be updated based on the first source confidence metric 253. This will now be illustrated using a few examples.

In a first such example, exponential decay weighting is exploited. At least one, such as several or even all existing topic confidence metrics 251 are adjusted based on the recency of the data, and in particular how recently the existing pieces of content 240, the addition of which to the set of information 200 resulted in an adjustment of the existing topic confidence metric 251, were added. This is especially useful in dynamic environments where older information becomes less reliable over time.

The decay can be calculated as follows: new value of existing topic confidence metric=previous value of existing topic confidence metric*exp(−lambda*time), where lambda is a decay constant and time is the time since the last affecting piece of content was added.

The decayed topic confidence metric(s) can be calculated in connection to them being used to determine the first topic confidence metric 252.

In a second such example, a linear combination with thresholding is used. A weighted sum of the first source confidence metric 253 and the existing topic confidence metric(s) 251 is calculated, while ensuring that the result does not exceed a predetermined limit.

In practical examples, the existing topic confidence metric in question can be calculated as new value of existing topic confidence metric=min(1, alpha*first source confidence metric+beta*previous value of existing topic confidence metric). Here, alpha and beta represent the respective weights. Here, the predetermined limit is 1.

In an example, if an existing piece of content “John likes pizza” has an existing topic confidence metric of 0.85, and the first piece of content “John hates pizza” has a first source confidence metric of 0.4, using alpha=0.6 and beta=0.7, the result would be:

$$min ( 1 , 0.6 * 0.4 + 0.7 * 0.85 ) = min ( 1 , 0.24 + 0.595 ) = 0.835$$

This second approach offers a simple way to balance different confidence sources while ensuring the result stays within a predefined range (e.g., between 0 and 1).

In general, the central server 130 can be configured to determine that the existing topic confidence metric 254 indicates a higher confidence than the source confidence metric 253, and as a result thereof determining the first topic confidence metric 252 to indicate a lesser confidence than the existing topic confidence metric 254. The reverse may also be true, whereby the central server 130 can be configured to determine that the existing topic confidence metric 254 indicates a lower confidence than the source confidence metric 253, and as a result thereof determining the first topic confidence metric 252 to indicate a higher confidence than the existing topic confidence metric 254.

It is possible for two pieces of content 240 that are determined to be 100% true, according for instance to the corresponding source confidence metrics 232, to conflict. In such cases, the method can comprise special case conflict resolution mechanism.

In a first example of such a special case conflict resolution mechanism, the central server 130 is configured to allow a human operator, or a system external machine user, to manually resolve the conflict in terms of setting corresponding topic confidence metrics 251 to values making it possible to determine which one of two or more conflicting pieces of content 240 is most likely true. For example, an administrator can be allowed to review the conflicting entries “John loves pizza.” and “John hates pizza.” to make a final decision upon the corresponding topic confidence metrics 251 to be stored in the set of information 200.

In a second example, a community-based resolution can be employed. Then, the corresponding topic confidence metric 251 for each of the conflicting pieces of content 240 can be set by a community of human or system external machine users, for instance by voting, along a continuous scale such as between 0 and 1. For example, the more such users that agree with either side, the higher the confidence rating, unless the corresponding source confidence metric 232 is under 0.5. Concretely, multiple entries supporting “John loves pizza” and “John hates pizza” can be tallied, and the corresponding topic confidence scores 251 can be adjusted reflect the majority opinion, adjusting dynamically as more data is added.

In a subsequent step S114, the method ends. However, as illustrated in FIG. 3, the method can iterate by receiving an additional first piece of content 240, and so on, several times.

As mentioned above, in some embodiments, each information source 210 can individually be marked as a primary, secondary, tertiary, etc. information source with respect to a particular identified topic 220. More particularly, at least one, such as several or even each, of the existing source confidence metrics 232 comprises information reflecting whether an individual information source 210 associated with the existing source confidence metric 232 is a primary, secondary and/or tertiary information source 210 for the individual existing topic 220 in question.

In some embodiments, secondary or tertiary information source status for a particular information source 210 with respect to a particular topic 220 can be automatically determined based on the provided first piece of content 241.

Hence, in a step S115 the central server 130 can be configured to identify that an additional information source 212 occurs in the first piece of content 241 or 243 and further that the first piece of content 241 refers to information regarding an additional topic 224 the information source 210 of which is the additional information source 212. For instance, if the first piece of content 241 is “Bill told Bella that John just loves pizza”, the central server 130 can identify that “Bill” is a source of information 210 (the additional information source 212) for topic “John” (the additional topic 224 in this terminology. In case the first piece of content 241 is instead “Bill told Bella that skateboarding is fun”, “Bill” is still the additional information source 212 but the additional topic 224 is now “skateboarding”. This determination of the additional information source 212 and the additional topic 224 can take place by constructing a suitable prompt to an LLM and receiving a response from the LLM, in a way corresponding to the above described steps S107, S108, S111 and S112. In particular, such prompt can be on the exemplary format “Given the following content: ‘Bill told Bella that John just loves pizza’, indicate in a simple list any secondary providers of particular information, along with such particular information”, while the response can be “Bill, ‘Johan loves pizza’”.

In case at least one such secondary information source is identified, the central server 130 can, in a step S116, be configured to determine, and store in the set of information 200, that the first information source 211 is a secondary information source for the additional topic 224.

More generally, step S115 of the present method can comprise providing a third prompt to a third neural network or LLM 170 or to the first or second neural network or LLM 150 or 160, the third prompt being configured to request neural network 150, 160 or 170 in question to provide information regarding any additional sources of information referred to in the first piece of content 241 as well as any additional topics in that case referred to by such additional sources of information.

In response from the neural network or LLM in question 150, 160 or 170, a third piece of response information can then be received, regarding the additional information source 212 and the additional topic 224. The response can be, for instance “no such additional sources are present in the piece of content”. Then, step S116 can simply be skipped.

As mentioned above, it can happen that one or several of the topics in the first piece of content 241, and in particular one or several of the identified topics 222, do not exist in the set of existing topics 220. Such non-existing topics are herein referred to as “particular topics 225”. The mapping of identified topics 222 to existing topics 220 can take place using fuzzy comparison methods, such as using vector-space closeness or other distance measures, for instance based on character-level modification distance measures, so that complete identity between identified topic 222 and existing topic is not required for the mapping to be successful. For instance, an identified topic 222 “banana” can be successfully mapped to existing topic “bananas” by a closeness measure dictating that two nouns can be mapped to each other if identical save for any differences in plural forms or other word endings.

However, if no mapping is possible, the one or several identified particular topics 225 can be stored, in the one or several databases 140 and generally in the set of information 200, to the set of existing topics 220. Correspondingly, an association 231 between the first information source 211 and the particular topic 225 can be stored to the set of existing associations 230. This new association 231 can then be provided with a default source confidence metric 233. Of course, one or several particular topics 225 can also be identified in a split first piece of content 243 of the above-described type.

In some embodiments, the set of information 200 comprises information regarding relations between topics 220. Such information can be automatically identified, such as using prompting to any one of the neural networks or LLMs 150, 160 or 170 using the prompting techniques generally described above, querying to identify any relationships between individual topics 220 in the first piece of content 241 or 243. Information regarding any such identified relationships can then be stored in the set of information 200, such as in association with or as part of the existing topic 220 being associated with the related topic 220. Such identified related topics can be used in various ways, for instance by extending the list or set 221 of identified topics 222 by also incorporating the set of zero or more identified related topics that have been identified to relate to each of the identified topics 222, before determining the first subset of topics 246, or the set of particular pieces of content 242 based on the extended set 221 of identified topics 222.

In a simple example, a prompt to an LLM 150, 160 or 170 is: “We have just created a new topic of birds as a result of the following content: ‘I like birds’. Should any of these other topics be associated with birds? ‘animals, canines, people, places, and food’. Please respond with a simple list of topics to be associated with birds”. The response might be reply: “animals”.

Hence, in this case steps S110 and forwards can be performed on the extended list or set 221 of identified topics 222, in other words for each of the one or several identified topics 222 of the list or set 221 of identified topics 222 in addition to any other topics having been identified as being related to one or several of the identified topics 222.

As mentioned above, additional context (for instance “chat between Mark and John”) can be stored in the set of information 200, together or associated with individual pieces of content 240. Such additional context is one example of metadata regarding the first piece of content 241 that can be stored, as a part of step S109, with or in association with the first piece of content 241. Another example of such metadata is access rights, whereby different pieces of content can be associated with different access rights for different participants 122. In some cases, individual existing topics 220 can comprise or, alternatively, be associated with metadata in the form of access rights.

When the central server 130 receives a request or query for information to be responded to using the set of information 200, such metadata can be exploited. For instance, a querying entity can ask the central server 130 for information regarding pizza occurring in conversations between Mark and John. Then, the central server 130 can use the metadata to filter out information originating in conversations between Mark and John, and also pay attention to if the querying entity has sufficient access rights to the requested information. In case access rights apply to an existing topic 220, it may also apply to all existing pieces of content 240 that are associated, in the set of information, with the existing topic 220 in question.

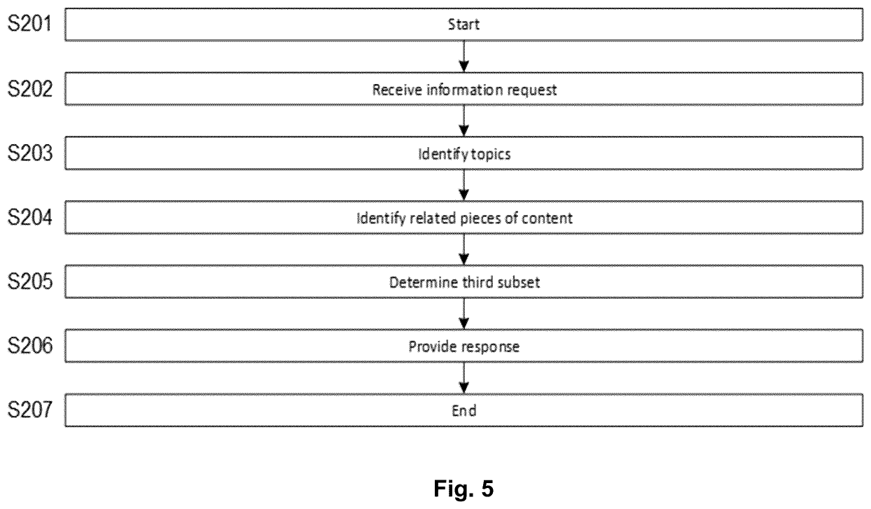

FIG. 5 illustrates a method, performed by the central server 130 in a way corresponding to what has generally been said regarding the method illustrated in FIG. 3, for responding to a query or request arriving from a querying or requesting entity, such as a participant 122, any of the devices 120 or 121, or from an autonomous entity 125.

In a first step S201, the method starts. It is noted that this method can be a component part of the method illustrated in FIG. 3, and that steps S201 and forwards can then be performed in parallel to, or after, one or several of steps S102-S113.

In a subsequent step S202, an information request 310 can be received, the information request 310 being in the form of a query or question.

In a subsequent step S203, one or several topics 226 can be identified as being present in, or related to, the information request 310. This identification can take place in a way corresponding to the identification of the several potential topics 223 and/or identified topics 222 described above, including any expansion of the one or several topics 226 using stored information regarding relationships between topics 220 of the type discussed above. In particular, the identifying of the topic 226 can be performed using a similarity search using the set of existing topics 220 being stored in a vectorized form, such as by using a geometric distance measure in vector space.

In a subsequent step S204, a set of related pieces of content 245 can be identified. Each such related piece of content 245 can form part of the set of existing pieces of content 240 and be associated with the identified topic 226. Alternatively, each such related piece of content 245 can be a topic being related to the identified topic 226 based on a predetermined metric, such as a vector space distance measure being sufficiently small and/or by explicit relationship status information being stored, as described above, as a part of the set of information 200.

Then, in a step S205, a third subset 248 can be determined, of the set of related pieces of content 245 having highest respective topic confidence metric 251 for the identified or related topic 226. The “highest respective topic confidence metric 251” can mean the one or several related pieces of content 245 representing a highest percentage with respect to topic confidence metric 251; having respective topic confidence metrics 251 above a predetermined minimum value; or similar.

In a subsequent step S206, a response 311 to the information request can be provided based on the third subset 248 of the set of related pieces of content 245. In simple embodiments, the response 311 can be the text of the pieces of content 240 in the third subset 248. In more elaborate embodiments, the response 311 can be produced by text processing, such as by feeding the third subset 248 to either one of the neural networks or LLMs 150, 160, 170 in a prompt requesting a response based on the third subset 248 of pieces of content 240 and according to a particular desired response format. The desired response format can for instance be indicated in the information request 310.

In a subsequent step S207, the method ends.

In general, the central server 130 can be configured to perform a similarity search, such as in vector space as generally discussed above, by comparing vector representations of information comprised in the query or request with information, such as pieces of content and/or topics (and then pieces of content being associated with such identified similar topics). Then, the potentially large set of resulting similar contents can be filtered based on topic confidence metric 251 so that only pieces of content with topic confidence metrics 251 indicating high confidence (as determined using any suitable predetermined percentage or absolute criterion) are used in the response. The final response can be provided by an LLM 150, 160 or 170 that is prompted with a list of the filtered similar information, and in particular with such a list of pieces of content.

### Example 1—Blockchain-Based Solution

In an exemplary implementation, a blockchain-based system 101, comprising a blockchain 190, is used by the central server 130 to store the set of information 200 including the various information discussed above in terms of confidence metrics, associations, sources, topics and pieces of content. The blockchain 190 ensures that all data entries are immutable and tamper-proof, making it impossible to retroactively alter or delete any data. The confidence metrics discussed above are calculated using respective smart contracts, which dynamically adjust the ratings based on predefined rules and input data. Whenever a conflict is detected, the smart contract resolves it by adjusting the confidence metrics of the conflicting entries as discussed above.

A document-oriented database (memory 140) is used to store the various data entries. Hence, each data entry is stored as a document with fields for the topic, content, confidence metrics, any metadata, and so forth.

Whenever a new data entry is added, it is verified by the blockchain network using a consensus algorithm, such as Proof of Work (PoW) or Proof of Stake (POS). Once the entry is verified, the blockchain 190 can update the confidence metrics dynamically, such as using smart contracts and/or using machine learning algorithms that learn from the existing data. Smart contracts are self-executing contracts with the terms of the agreement between buyer and seller of a suitable crypto resource being directly written into lines of code. They enforce the rules and penalties of the agreement automatically.

All pieces of content and their associated confidence metrics are stored on the blockchain 190, which ensures that all changes are immutable and tamper-proof. The central server 130 stores new pieces of content with associated topics and their confidence metrics in blocks. The blockchain network 101 uses a consensus algorithm to validate and add new such blocks to the blockchain 190. This ensures that the blockchain 190 is secure and resistant to attacks.

To control ownership of individual topics, the central server 130 can use a permissioned blockchain 190 for performing the above-mentioned activities. This will restrict access to the network to authorized participants 122. Each participant 122 can be assigned a unique digital identity, which is used to control access to specific data entries (such as pieces of content and/or topics).

The central server 130 can use so-called access control lists (ACLs) to specify which participants 122 have access to which data entries. This ensures that each participant 122 has control over their own data and that conflicts are resolved by the participants 122 themselves.

More particularly, the set of existing information sources 210, the set of existing topics 220, the set of existing associations 230 between pairs of individual ones of the existing information sources 210 and individual ones of the existing topics 220 and the set of existing pieces of content 240 can be stored on the blockchain 190. The blockchain 190 can then be caused to comprise one or several different smart contracts configured to automatically update a topic confidence metric 251 (252) as a result of the introduction of the first piece of content 241 into the blockchain 190.

The introduction of new data into the blockchain 190 generally takes place by providing a blockchain transaction and processing the blockchain transaction for instance using said consensus algorithm so as to incorporate the transaction into the blockchain 190 in an immutable manner.

### Example 2: Machine Learning-Based Solution

In this implementation, the central server 130 is configured to use machine learning algorithms to learn from the existing data entries, such as pieces of content, and their associated confidence metrics (of the above-discussed types). These algorithms then use this learning to dynamically adjust the confidence metrics of new data entries based on their similarity to existing entries. Whenever a conflict is detected, the algorithms can use predefined rules to adjust the confidence metrics of the conflicting entries and resolve the conflict.

### Example of Training Process:

1. Initial State: The server begins with existing entries in the document-oriented database, such as:
   Entry 1: “John likes pizza” with a confidence of 0.6.
   Entry 2: “John actually doesn't like pizza that much” with a confidence of 0.8.
2. New Entry and Feedback Loop: A new entry (the first piece of content 241) comes in: “John eats pizza every week.” The central server 130 needs to decide whether this new entry increases or decreases the respective existing content confidence metrics 251 of existing entries (existing pieces of content 240), such as “John likes pizza.”
3. Learning from Feedback: Feedback from users (participants 122) is gathered. If users confirm the new statement (“John eats pizza every week”) as true, the reinforcement learning algorithm increases the existing topic confidence metric of existing piece of content “John likes pizza” (since the new entry supports that claim). If users dispute the new claim, the topic confidence metric is instead decreased.
4. Reward Signal: Each feedback entry acts as a reward signal:
   Positive feedback increases the topic confidence metric for “John likes pizza.”
   Negative feedback decreases the topic confidence metric.
5. Conflict Resolution: If conflicting feedback is present (some users agree, others disagree), the algorithm uses predefined rules to decide. For example, if the feedback on “John doesn't like pizza” is more recent and comes from trusted sources, it might override older conflicting information.

Again, the central server 130 can use a document-oriented database to store the data entries.

Reinforcement learning (RL) algorithms can be used to learn from feedback provided by participants 122, and to adjust the confidence metrics accordingly. In this setup, the central server 130 acts as the agent and the data entries (pieces of content 140) as the environment. The topic confidence metric 251 (representing how trustworthy or accurate a piece of content 140 is) is the action being adjusted, while participant 122 feedback is the reward signal guiding the agent's learning process.

Herein, an “agent” refers to an autonomous entity or automated functionality within a system that interacts with the environment, such as a bot or neural network (e.g., the autonomous entity 125). It processes and responds to inputs, like monitoring conversations or analyzing data, in order to resolve conflicts in information or perform other tasks such as summarization or compliance checking.

Herein, an “environment” refers to the overall system setup that includes the set of information 200, querying devices 120, 121, central server 130, and any participants 122 (both human and machine). This environment continuously changes with the addition, removal, and modification of information, such as text-based communications or data processing within the system 100.

Herein an “action” refers to any task or process performed by the agent within the environment. Actions include analyzing and splitting content, identifying potential topics, generating prompts for neural networks (e.g., LLMs 150, 160, 170), and processing or updating the set of information 200 based on the received data or content (the first piece of information 141). Actions lead to outcomes that alter the system's 100 state, such as resolving a conflict in the data.

Herein, a “reward signal” can be interpreted as the outcome or feedback that informs the system 100 whether an action led to a correct or desired result. In the present context, the reward signals could be implicit, such as the successful conflict resolution of data or the correct identification of topics from the first piece of content 141, improving the accuracy or trustworthiness of the data being processed by the system 100.

### Example

Scenario: A participant 122 provides feedback (that can be the first piece of content 241) that contradicts a piece of content 140 entry about a topic 120 (e.g., the system stores “John hates pizza,” but a participant 122 feedback says “John loves pizza”).
Action: The RL algorithm adjusts the topic confidence metric 251 for the existing piece of content 140 “John hates pizza” downward and increases topic confidence metric 252 in the entry that aligns with the new feedback.
Reward signal: Positive feedback (agreement with existing data) leads to reinforcing confidence in that data; negative feedback (contradiction) decreases confidence. Over time, the central server 130 learns which entries are more reliable based on aggregated feedback from participants 122.

By using RL, the central server 130 learns which actions (topic confidence metric 251 adjustments) lead to better alignment with user feedback, continuously improving the system's trustworthiness.

The following is an explanation of how this process can happen, as a set of individually optional operations:
1. Initial State Definition: The central server 130 begins with a set of pre-defined parameters, including the existing topic confidence metrics 251, which represents how confident the system 100 is in its understanding of various existing topics that can be presented to the user 122.
2. Action Space: The central server 130 has several possible actions it can take to adjust these metrics. These actions might involve increasing or decreasing the topic confidence level 251 for specific topics 220 based on feedback, introducing new topics, or modifying existing ones.
3. Feedback Collection: After the central server 130 presents information to the user 122, it collects feedback, either explicitly (through user ratings, corrections, or annotations) or implicitly (via user behavior, such as how much time they spend engaging with certain content, clicks, or selection patterns).
4. Reward Signal: The feedback serves as a reward signal. Positive feedback (e.g., correct predictions or high engagement) reinforces the current topic confidence metric adjustments, while negative feedback (e.g., user corrections or lack of engagement) serves as a penalty, indicating the central server 130 needs to adjust its actions.
5. Policy Update: The central server 130 applies reinforcement learning algorithms, such as Q-learning or policy gradient methods, to update its action-selection policy. This policy dictates how the central server 130 adjusts the existing topic confidence metric 251 in the future. The central server 130 continuously evaluates which actions (adjustments to the topic confidence) lead to the most positive user feedback.
6. Continuous Learning Loop: As more data is gathered from user interactions, the central server 130 refines its decision-making process. Over time, it becomes better at predicting which adjustments will lead to higher user satisfaction, thus improving alignment with user expectations and enhancing trustworthiness.

This cyclical process—taking actions, receiving feedback, adjusting policies-enables the central server 130 to dynamically optimize the topic confidence metrics in real-time, leading to better system 100 performance and user satisfaction.

The central server 130 can use active learning algorithms to select the most informative data points for human annotation.

Active learning algorithms prioritize selecting the most informative data points for human annotation to improve learning efficiency. The central server 130 identifies data points where the model is uncertain or data that may have high impact on improving the model's performance if correctly labeled.

The following is an example:
Scenario: The central server 130 encounters a new content entry with conflicting or ambiguous information, such as “John enjoys pepperoni pizza” versus “John doesn't eat meat.” This can be done using LLM prompting as described above, requesting an LLM 150, 160 or 170 to provide information as to if particular pairs of content 140 contradict, support or are neutral in relation to each other and in relation to particular topics 120.
Active learning: The central server 130 selects these conflicting entries as high-priority candidates and sends them to a human annotator 122 for clarification (e.g., “Does John eat meat?”). The question posed to the human annotator can be provided by an LLM 150, 160 or 170 in response to a prompt requesting the LLM to provide a question the yes/no response to which would resolve a particular detected conflict.
Result: Human annotations resolve conflicts and improve the model's understanding of John's preferences, enabling the central server 130 to provide more accurate recommendations.

Active learning reduces the need for large-scale labeling by focusing on uncertain or influential examples, making human intervention more efficient.

The central server 130 can use precision, recall, and F1 score to self-evaluate the performance of its machine learning models. These metrics help the central server 130 to understand its ability to correctly classify or retrieve relevant content and make reliable adjustments. Here, a previously labelled set of verified data, where the data has been labelled as being “correct” is used to compare the central server's 130 ability to reliably quantify the reliability of incoming information (setting the first topic confidence metric 252 with respect to the first piece of content 241). The verified data can have been verified previously using a manual process, using a different external system, or similar.
Precision: The ratio of correctly identified relevant content to all identified content, based on some suitable predetermined definition of what is meant by “correctly identifying relevant content”.
   Example: Out of one hundred entries labeled as “John likes pizza,” eighty were correct, giving a precision of 80%.
Recall: The ratio of correctly identified relevant content to all relevant content that should have been identified.
   Example: If there were one hundred and twenty total entries about “John likes pizza,” and eighty were correctly identified, the recall is 66.67%.
F1 Score: The harmonic mean of precision and recall, providing a balanced measure.
   Example: With a precision of 80% and recall of 66.67%, the F1 score is approximately 72.7%.

These metrics enable the server to measure its effectiveness and identify areas for improvement in real-time. Such improvements can comprise adjustments of the existing topic confidence metrics 252 for existing topics 220 and/or existing pieces of content 240 in areas that are not deemed to be effectively handled by the central server 130 as measured in any of the ways described above.

Furthermore, online (in the sense “continuous” and/or “centralized”, performed by the central server 130) learning algorithms can be used to adapt to changes in the data and improve performance over time.

Online learning is a type of machine learning that enables models to be updated incrementally as new data arrives, rather than requiring the entire model to be retrained from scratch. This approach is particularly useful in dynamic environments where data changes frequently, such as real-time content processing systems. In the central server 130, that continuously processes user interactions and content updates, online learning allows the model to adapt quickly without overwhelming system resources.

In an example use case regarding updating of information regarding user preferences, the set of information 200 comprises pieces of content 140 that track user preferences for food, with data entries like: “John likes pizza.” and “John enjoys pepperoni pizza.”

Now, suppose the central server 130 receives the following new piece of content 140: “John has recently become a vegetarian.” This new data potentially conflicts with previous entries related to John's preferences for meat-based foods, such as pepperoni pizza. Using online learning, the central server 130 can handle this new information in real-time, adjusting its internal model and confidence metrics accordingly.

The following is a description of a step-by-step process for doing this.
1. Initial state:
   The central server 130 stores existing pieces of content 140 about John's preferences (e.g., “John likes pizza” with a topic confidence metric 251 of 0.8 and “John enjoys pepperoni pizza” with a topic confidence 251 of 0.7).
   It uses this data to make food recommendations for John, based on past preferences.
2. New data arrival:
   A new piece of content 141 arrives: “John has recently become a vegetarian.”
   This new information may conflict with earlier entries, particularly those involving meat (e.g., “John enjoys pepperoni pizza”).
3. Incorporating new data via online learning:
   Rather than retraining the entire model, the online learning algorithm updates the relevant parts of the model related to food preferences.
   The model adjusts its parameters, lowering the topic confidence metric 251 in “John enjoys pepperoni pizza” (from 0.7 to something lower, like 0.4) and increasing the topic confidence metric 251 in the new entry about vegetarianism (e.g., to 0.9). The parameters to adjust, such as individual existing topic confidence metrics 251, can be identified, for instance, using vector space closeness between embeddings of topics and/or pieces of content, as has been generally described above. The adjustment can take place, for instance, using optimization techniques like stochastic gradient descent where a difference (error) is calculated between the old prediction and the new information. Parameters can hence be adjusted step-by-step to reduce this error, gradually reflecting the new preference. This allows the model to update its understanding efficiently without needing to retrain on all the past data.
4. Conflict detection:
   The central server 130 detects a potential conflict between the new information (“John is a vegetarian”) and the existing entry (“John enjoys pepperoni pizza”).
   It resolves this conflict by adjusting the topic confidence metrics 251 accordingly—lowering confidence in the meat-based preference while strengthening confidence in the vegetarian preference.
5. Confidence metric adjustments:
   The online learning system of the central server 130 uses predefined rules or machine learning techniques to dynamically adjust topic confidence metrics 251. For example, it may reduce the topic confidence metric 251 for “John enjoys pepperoni pizza” and increase the topic confidence metric 251 for the newly added vegetarian content based on recency and relevance. This may entail iterating through at least parts of the set of information 200 (such as information relating to topics related to the first piece of content 141 as described above) and use a neural network to adjust weights based on existing source and/or topic confidence metrics in combination with the first source confidence metric.
6. Model update:
   The central server 130 updates its model predictions based on the adjusted data. Going forward, when the central server 130 makes food recommendations for John, it will prioritize vegetarian options over meat-based options, reflecting the most current understanding of his preferences.

In the following, a number of different possible ways of updating the neural network parameters as a function of added pieces of information.

### Stochastic Gradient Descent (SGD).

How it works: The most common mechanism for updating neural network parameters is stochastic gradient descent. When new data (e.g., “John has recently become a vegetarian”) arrives, the system calculates the error between the predicted output and the true label. SGD adjusts the parameters (weights and biases) in the neural network to reduce this error. Updates are performed in small steps for each new data point rather than in bulk for the entire dataset.
Why it's used: SGD allows incremental learning. Instead of retraining the entire model from scratch with all the data, the parameters are updated continuously as new data comes in, which is ideal for online learning.
Consequence: The network gradually adapts to changes in the data distribution, like John becoming a vegetarian, by shifting confidence away from earlier preferences. The risk, however, is slower convergence, especially if the learning rate is not tuned properly. If the learning rate is too high, the updates may overshoot, causing instability; if too low, the updates might be too slow to keep up with real-time data.
   2. Backpropagation with Mini-Batch Updates.
How it works: In cases where data arrives in small batches (e.g., multiple conflicting pieces of content at once), mini-batch gradient descent can be used. Instead of updating the network after each individual data point, the system waits until a small batch of new data is collected (say, several new pieces of content about John's preferences). Backpropagation is used to calculate the gradients of the error with respect to the parameters, and these gradients are then used to update the parameters.
Why it's used: Mini-batch updates strike a balance between computational efficiency and the noise inherent in single data-point updates. This method smooths out some of the variance in updates, which can lead to faster and more stable convergence.
Consequence: This method reduces the chance of noisy updates but requires waiting for a small batch of data to accumulate, which could slightly delay model adaptation in highly dynamic environments.

### 3. Elastic Weight Consolidation (EWC).

How it works: EWC is a mechanism that helps prevent catastrophic forgetting-a common issue in online learning where the model forgets previously learned information when new data is introduced. EWC penalizes changes to parameters that are crucial for past tasks by calculating an importance score (often based on the Fisher Information Matrix) and constraining those parameters from changing too much during updates.
Why it's used: This method is useful when the system needs to incorporate new knowledge (e.g., John becoming a vegetarian) without losing important prior information (e.g., John likes certain vegetarian dishes). It helps the model retain both old and new knowledge without retraining.
Consequence: While it mitigates catastrophic forgetting, EWC may slow down the adaptation to new data since some parameters cannot be updated as freely. If used excessively, the system could become rigid and less responsive to new data. Finding the right balance between retaining old knowledge and learning new information is critical.

### 4. Learning Rate Scheduling

How it works: Learning rate scheduling is a mechanism where the learning rate is gradually reduced as the model continues to learn. In early stages, the learning rate is high to allow for large parameter updates, while in later stages, it's reduced to make more fine-grained adjustments to the parameters.
Why it's used: This mechanism allows for fast adaptation initially but becomes more conservative as the model starts to settle into a more stable configuration. When new conflicting data like “John has recently become a vegetarian” is introduced, the model can initially make large adjustments but then fine-tune these adjustments over time as more data about John's vegetarianism comes in.
Consequence: This ensures that the model doesn't overreact to new data but can still adjust quickly when needed. However, if the learning rate reduces too quickly, the system may become too slow to adapt to future changes in the environment.

### 5. Regularization Techniques (L2 Regularization, Dropout).

How it works: Regularization techniques are used to prevent the model from becoming too dependent on a particular set of weights, ensuring that it can generalize well to new data. L2 regularization, for instance, adds a penalty term to the loss function that discourages large weights, while dropout randomly drops units in the network during training, making the network more robust.
Why it's used: Regularization helps the model remain flexible and avoid overfitting to older, static data (e.g., “John likes pepperoni pizza”), allowing it to more effectively adapt to new data like “John has recently become a vegetarian.”
Consequence: These techniques make the model more generalizable and robust to shifts in data, but they also introduce a small amount of noise into the parameter updates, which could slightly slow down learning.

### 6. Replay Buffer or Experience Replay.

How it works: In this mechanism, the system stores a buffer of past data points, randomly sampling from this buffer to update the model during training. This helps the model to “remember” past information even as it learns from new data.
Why it's used: This method is particularly useful in online reinforcement learning, where the model might forget older data as it focuses on new data. By replaying past experiences (e.g., John's older preferences for pizza), the model can maintain balance between past and present preferences.
Consequence: The replay buffer allows the system to retain knowledge of past preferences, reducing the risk of catastrophic forgetting. However, managing and sampling from this buffer can add complexity to the system, and there's a trade-off between how large the buffer is and how much it slows down real-time learning.

### 7. Adaptive Moment Estimation (Adam Optimizer).

How it works: Adam is a widely used optimizer in neural networks that adjusts the learning rate dynamically for each parameter based on the first and second moments of the gradients. It combines the benefits of both SGD and momentum-based methods to ensure faster convergence.
Why it's used: Adam adjusts the learning rate on a per-parameter basis, allowing the model to converge faster and more stably. This is particularly helpful when handling conflicting or rapidly changing information (e.g., John's switch to vegetarianism) by providing more controlled updates.

Consequence: Adam can lead to faster learning with fewer oscillations, but it requires careful tuning. Misconfigured hyperparameters could cause the model to overfit or learn too slowly.

### Example 3—Hybrid Solution

In this implementation, a combination of blockchain 190 and machine learning is used to resolve conflicts in shared datasets. The blockchain 190 is used to store the data entries and their associated confidence metrics, while machine learning algorithms are used to dynamically adjust the metrics based on predefined rules. Whenever a conflict is detected, the algorithms use predefined rules to adjust the confidence metrics of the conflicting entries, and the blockchain 190 ensures that all changes are immutable and tamper-proof.

Above, preferred embodiments have been described. However, it is apparent to the skilled person that many modifications can be made to the disclosed embodiments without departing from the basic idea of the invention.

For instance, the system 100 may comprise additional functionality, in addition or alternatively to the examples provided herein, for monitoring, receiving and/or storing information, and/or to process queries or requests for information processed by the system 100 for conflict resolution.

For instance, the central server 130 can comprise additional modules for processing the information in additional ways, such as a logic module for processing the stored information so as to be logically stringent; a math module for performing any mathematical calculations required for such processing; an external information motor arranged to align or supplement the stored information with externally provided information such as a news feed, fact databases and so forth.

The functionality described above, performed by the central server 130 to manage the set of information 200 in response to incoming pieces of information 241 and to respond to queries regarding the managed set of information 200, can be used as a part of a broader system. As described above, human or machine participants 122 can provide the pieces of information 241 via an appropriate API of the central server 130 and/or provide said queries (and receive responses to the queries) via an appropriate API of the central server 130. In other cases, an information-handling entity, being part of or external to the system 100, can use the central server 130 to keep an updated view of the set of information 200 where the set of information 200 is used by said entity to perform some kind of task. For instance, the entity can manage a communication service, a social media or any other text- or voice-based communication platform, or any other type of activity, such as register-keeping, planning tools or monitoring services, in which it is important to manage information that can include semantic ambiguity.

Generally, all that has been said herein regarding the methods, the system and the compute software product is freely applicable to all these aspects of the invention, in any combination.

Hence, the invention is not limited to the described embodiments, but can be varied within the scope of the enclosed claims.

1. A method for resolving a conflict in a set of information, comprising:
identifying and storing in one or several databases, in referenced and/or actual format,
a set of existing information sources;
a set of existing topics;
a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics;
receiving a first piece of content, the first piece of content being associated with a first information source, the first information source being an originator or provider of the first piece of content;
providing a first prompt to a first large language model (LLM), the first prompt being configured to request the first LLM to provide a set of identified topics addressed in the first piece of content;
receiving, in a response from the first LLM, a first piece of response information comprising the set of identified topics; and
storing, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic, wherein
the method further comprises, for each of the one or several identified topics of the set of identified topics, the identified topic forming part of the set of existing topics, performing the following steps:
identifying a first subset of the existing pieces of content that are related to the identified topic;
providing a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receiving, in a response from the second LLM, a second piece of response information indicating that the first piece of content contradicts a particular existing piece of content of the first subset of existing pieces of content; and
determining the first topic confidence metric based on a source confidence metric between the first information source and the identified topic, the first topic confidence metric further being determined based on an existing topic confidence metric for the identified topic and the particular piece of content.

2. The method of claim 1, wherein one or several of the existing topics in the set of existing topics is stored as vectorized information.

3. (canceled)

4. The method of claim 1, wherein one or several of the existing pieces of content in the set of existing pieces of content is stored as vectorized information.

5. (canceled)

6. The method of claim 1, wherein the first piece of content is plaintext information.

7-10. (canceled)

11. The method of claim 1, wherein each of the existing source confidence metric comprises information reflecting whether an individual information source associated with the existing source confidence metric is a primary, secondary and/or tertiary information source for the individual existing topic.

12. The method of claim 11, further comprising:
identifying an additional information source occurring in the first piece of content and identifying that the first piece of content refers to information regarding an additional topic the source of which is the additional information source; and
determining that the first information source is a secondary information source for the additional topic.

13. The method of claim 12, further comprising:
providing a third prompt to a third LLM, the third LLM being the same as or different from the first and/or second LLM, the third prompt being configured to request the third LLM to provide information regarding any additional sources of information referred to in the first piece of content and topics referred to by such additional sources of information; and
receiving, in response from the third LLM, a third piece of response information regarding the additional information source and the additional topic.

14. The method of claim 1, further comprising:
determining that a particular topic of the first piece of content does not exist in the set of existing topics; and
as a result thereof, storing in the one or several databases
to the set of existing topics, the particular topic; and
to the set of existing associations between pairs of individual ones of the existing information sources and individual ones of the existing topics, an association between the first information source and the particular topic with a default source confidence metric.

15-16. (canceled)

17. The method of claim 1, further comprising:
splitting the first piece of content into two or more separate pieces of content; and using each of the two or more separate pieces of content as the first piece of content.

18. The method of claim 17, wherein the splitting of the first piece of content into two or more separate pieces of content is configured to result in a partial overlap between the two or more separate pieces of content.

19. The method of claim 1, further comprising:
continuously reading an available alphanumeric stream of information;
parsing or splitting the alphanumeric stream of information into a sequence of separate pieces of content; and
using the sequence of separate pieces of content as the first piece of content.

20. The method of claim 19, wherein;
the available alphanumeric stream of information is a chat or other text-based communication involving at least two participants, or a transcript of a non-text communication involving the at least two participants, and
each participant is noted as an information source for each communication message produced by that participant.

21. (canceled)

22. The method of claim 1, wherein the determining of the first topic confidence metric for the combination of the first piece of content and the identified topic is performed at a later point in time, after a second piece of content has been received and processed as the first piece of content.

23. The method of claim 1, further comprising:
determining that the existing topic confidence metric indicates a higher confidence than the source confidence metric; and
as a result, determining the first topic confidence metric to indicate a lesser confidence than the existing topic confidence metric.

24. The method of claim 1, wherein the determining of the first topic confidence metric is performed using one or several of:
adjusting the first topic confidence metric by multiplying the first topic confidence metric with a function of a negated value of the existing topic confidence metric;
forming a weighted average or geometric mean of the first topic confidence metric and the existing topic confidence metric, and using the weighted average or geometric to determine the first topic confidence metric;
calculating the first topic confidence metric using a Bayesian statistic model; and
calculating the first topic confidence metric using a maximum likelihood model; and
a neural network trained on historic information regarding adjustments of source confidence (metrics) 232 and/or topic confidence metrics.

25. The method of claim 1, further comprising:
receiving an information request, the information request being in the form of a query or question;
identifying a topic present in, or related to, the information request;
identifying a set of related pieces of content, each related piece of content in the set of related pieces of content forming part of the set of existing pieces of content and being associated with the identified topic or a topic being related to the identified topic based on a predetermined metric;
determining a third subset of the set of related pieces of content having highest respective topic confidence metric for the identified or related topic; and
providing a response to the information request based on the third subset of the set of related pieces of content.

26. The method of claim 25, wherein the identifying of the topic present in, or related to, the information request is performed using a similarity search using the set of existing topics being stored in a vectorized form.

27. The method of claim 1, wherein:
the set of existing information sources, the set of existing topics, the set of existing associations between pairs of individual ones of the existing information sources and individual ones of the existing topics and the set of existing pieces of content are stored on a blockchain, and
the blockchain is caused to comprise a smart contract configured to automatically update a topic confidence metric as a result of the introduction of the first piece of content into the blockchain.

28. (canceled)

29. A system for resolving a conflict in a set of unstructured information, the system comprising a central server arranged to identify and store, in one or several databases, in referenced and/or actual format,
a set of existing information sources;
a set of existing topics;
a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics;
the central server further being arranged to:
receive a first piece of content, the first piece of content being associated with a first information source, the first information source being an originator or provider of the first piece of content;
provide a first prompt to a first large language model (LLM) the first prompt being configured to request the first LLM to provide a set of identified topics addressed in the first piece of content;
receive, in a response from the first LLM, a first piece of response information comprising the set of identified topics; and
to store, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic, wherein
the central server is further arranged to, for each of the one or several identified topics of the set of identified topics, the identified topic forming part of the set of existing topics, perform the following steps:
identifying a first subset of the existing pieces of content that are related to the identified topic;
providing a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receiving, in a response from the second LLM, a second piece of response information indicating that the first piece of content contradicts a particular existing piece of content of the first subset of existing pieces of content; and
determining the first topic confidence metric based on a source confidence metric between the first information source and the identified topic, the first topic confidence metric further being determined based on an existing topic confidence metric for the identified topic and the particular piece of content.

30. A computer program product, stored on a non-transitory computer readable medium, for resolving a conflict in a set of unstructured information, the computer program product being arranged to, when executing on one or several processors, identifying and store in one or several databases, in referenced and/or actual format,
a set of existing information sources;
a set of existing topics;
a set of existing associations between pairs of individual ones of the existing information sources and individual ones of the existing topics, the set of existing associations each comprising an associated existing source confidence metric; and
a set of existing pieces of content, each of the set of existing pieces of content being associated with one or several associated ones of the existing topics, each of the set of existing pieces of content also being associated with a respective existing topic confidence metric for each of the one or several associated ones of the existing topics;
the computer program product further being arranged to, when executing on the one or several processors,
receive a first piece of content, the first piece of content being associated with a first information source, the first information source being an originator or provider of the first piece of content;
provide a first prompt to a first large language model (LLM), the first prompt being configured to request the first LLM to provide a set of identified topics addressed in the first piece of content;
receive, in a response from the first LLM, a first piece of response information comprising the set of identified topics; and
store, in the one or several databases, in referenced or actual format, the first piece of content associated with one or several identified topics in the set of identified topics and, for each of the one or several identified topics in the set of identified topics, a corresponding respective first topic confidence metric for the combination of the first piece of content and the identified topic, wherein
the computer program product further being arranged to, when executing on the one or several processors, for each of the one or several identified topics of the set of identified topics, the identified topic forming part of the set of existing topics, perform the following steps:
identifying a first subset of the existing pieces of content that are related to the identified topic;
providing a second prompt to a second LLM, the second LLM being the same as or different from the first LLM, the second prompt being configured to request the second LLM to provide information regarding if the first piece of content supports, contradicts or is neutral in relation to one or several of the first subset of the existing pieces of content;
receiving, in a response from the second LLM, a second piece of response information indicating that the first piece of content contradicts a particular existing piece of content of the first subset of existing pieces of content; and
determining the first topic confidence metric based on a source confidence metric between the first information source and the identified topic, the first topic confidence metric further being determined based on an existing topic confidence metric for the identified topic and the particular piece of content.
